(19) United States
(12) Patent Application Publication
(10) Pub. No.: US 2024/0336833 A1
(43) Pub. Date: Oct. 10, 2024

(54) POLYCANNABINOIDS FOR COMMODITY POLYMERS AND COMMODITY ELECTRONICS

(71) Applicant: UNIVERSITY OF CONNECTICUT, Farmington, CT (US)

(72) Inventor: Gregory Allen Sotzing, Storrs, CT (US)

(21) Appl. No.: 18/627,866

(22) Filed: Apr. 5, 2024

Related U.S. Application Data
(60) Provisional application No. 63/457,302, filed on Apr. 5, 2023.

(51) Int. Cl. C09K 9/02; C08J 5/18; C09D 5/08; C09D 123/02; C09D 167/02; C09D 175/04; G02F 1/1516; H01G 4/14; H01G 4/33

(52) U.S. Cl. CPC C09K 9/02; C08J 5/18; C09D 5/08; C09D 123/02; C09D 167/02; C09D 175/04; G02F 1/15165; H01G 4/14; H01G 4/33; C08J 2367/02

(57) ABSTRACT

Disclosed herein are polycannabinoids and polycannabinoid compositions which find use as a commodity polymer and for commodity electronics. Suitable uses include coatings and paints. Polycannabinoids can be used as polymer dielectrics for capacitors and capacitive energy storage. Also disclosed are new electrochromic materials comprising polycannabinoids and a salt. Further disclosed are electrochromic devices prepared from the electrochromic materials and electrochromic material compositions.

### CROSS-REFERENCE TO RELATED APPLICATIONS

This disclosure claims the benefit of U.S. Provisional Application No. 63/457,302, filed Apr. 5, 2023, the contents of which are hereby incorporated by reference in its entirety for all purposes.

### TECHNICAL FIELD

The invention disclosed herein relates to polymeric materials, and in particular to polycannabinoid based compositions.

### BACKGROUND

Rising environmental pollution stipulates an increased focus on sustainability and circular economy. The current electrical and electronic equipment (EEE) industry relies on technologies that are constantly modified, leading to “e-waste” being the widest source of waste with the highest growth rate per year. Polymers are one of the highest components in EEE by volume, and current polymers used in EEE are mostly synthesized using petroleum-based sources and are not easily degradable. There is a need for solutions to reduce electronic waste and consumption of fossil fuels.

There remains a need in the art for new materials that can be used in EEE that are bio-based, naturally biodegradable, inexpensive to produce, and easy to produce, and exhibit a variety of properties such as substantially flexible, easily processed, melt-processable, electrochromic, capacitive energy storage properties, or any combination thereof.

### SUMMARY

Disclosed, in various embodiments, are electrochromic material compositions comprising a salt; a polycannabinoid; and optionally a plasticizer, a solvent, or a combination thereof, wherein the polycannabinoid comprises a plurality of cannabinoid units, wherein the polycannabinoid has the formula:

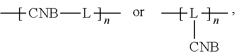

wherein:
CNB is a cannabinoid unit,
L is a linking group; and
n represents the number of repeat units wherein n is at least 2;
wherein the linking group comprises a di- or tri-carboxylic acid linking group comprising citric acid, fumaric acid, glutamic acid, maleic acid, malic acid, terephthalic acid, isophthalic acid, naphthalene-2,6-dicarboxylic acid, oxaloacetic acid, phthalic acid, butanedioic acid, oxalic acid, malonic acid, succinic acid, glutaric acid, adipic acid, pimelic acid (heptanedioic acid), suberic acid (octanedioic acid), azelaic acid (nonanedioic acid), sebacic acid (decanedioic acid), undecanedioic acid, dodecanedioic acid, pyridine-2,6-dicarboxylic acid, 1H-imidazole-4,5-dicarboxylic acid, furan-2,5-dicarboxylic acid, furan-2,3-dicarboxylic acid, thiophene-2,5-dicarboxylic acid, thiophene-2,3-dicarboxylic acid, quinoline-2,4-dicarboxylic acid, cyclohexane-1,4-dicarboxylic acid, cyclopentane-1,3-dicarboxylic acid, cyclobutane-1,3-dicarboxylic acid, or bicyclo[2.2.2]octane-1,4-dicarboxylic acid, or a bifunctional compound such as

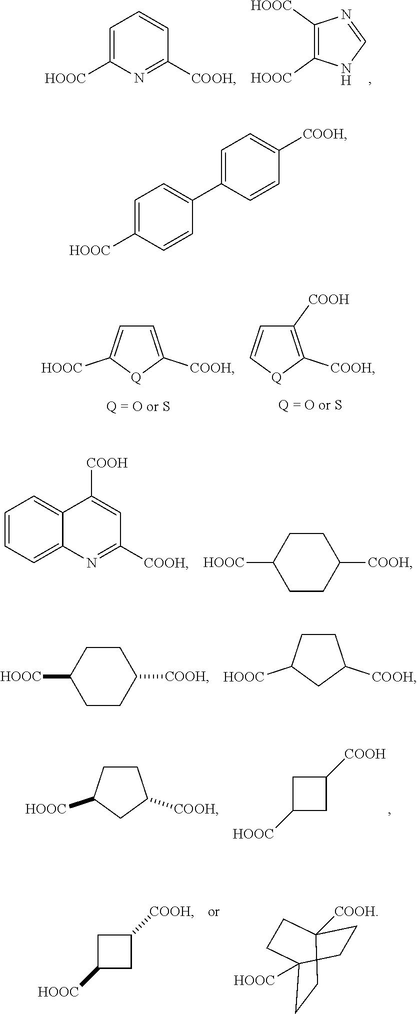

In another embodiment, a dielectric film capacitor comprises a polycannabinoid, wherein the polycannabinoid comprises a plurality of cannabinoid units, wherein the polycannabinoid has the formula:

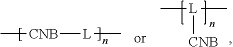

wherein:
CNB is a cannabinoid unit,
L is a linking group; and
n represents the number of repeat units wherein n is at least 2;
wherein the linking group comprises a di- or tri-carboxylic acid linking group comprising citric acid, fumaric acid, glutamic acid, maleic acid, malic acid, terephthalic acid, isophthalic acid, naphthalene-2,6-dicarboxylic acid, oxaloacetic acid, phthalic acid, butanedioic acid, oxalic acid, malonic acid, succinic acid, glutaric acid, adipic acid, pimelic acid (heptanedioic acid), suberic acid (octanedioic acid), azelaic acid (nonanedioic acid), sebacic acid (decanedioic acid), undecanedioic acid, dodecanedioic acid, pyridine-2,6-dicarboxylic acid, 1H-imidazole-4,5-dicarboxylic acid, furan-2,5-dicarboxylic acid, furan-2,3-dicarboxylic acid, thiophene-2,5-dicarboxylic acid, thiophene-2,3-dicarboxylic acid, quinoline-2,4-dicarboxylic acid, cyclohexane-1,4-dicarboxylic acid, cyclopentane-1,3-dicarboxylic acid, cyclobutane-1,3-dicarboxylic acid, or bicyclo[2.2.2]octane-1,4-dicarboxylic acid, or a bifunctional compound such as

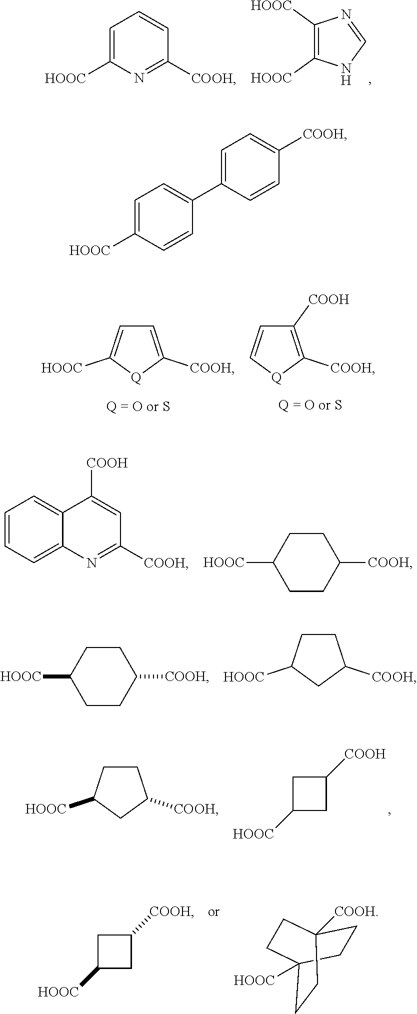

In another embodiment, a paint or coating comprises
a polycannabinoid and
a solvent or liquid carrier, a pigment, an extender, a rheology modifier, an additive, or a combination thereof,
wherein the polycannabinoid comprises a plurality of cannabinoid units, wherein
A.) the polycannabinoid is a polycannabinoid latex polymer prepared from emulsion polymerization of a cannabinoid monomer, optionally copolymerized with another monomer comprising an unsaturated group; or
B.) the polycannabinoid has the formula:

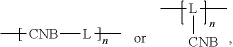

wherein:
CNB is a cannabinoid unit,
L is a linking group; and
n represents the number of repeat units wherein n is at least 2;
wherein the linking group comprises a di- or tri-carboxylic acid linking group comprising citric acid, fumaric acid, glutamic acid, maleic acid, malic acid, terephthalic acid, isophthalic acid, naphthalene-2,6-dicarboxylic acid, oxaloacetic acid, phthalic acid, butanedioic acid, oxalic acid, malonic acid, succinic acid, glutaric acid, adipic acid, pimelic acid (heptanedioic acid), suberic acid (octanedioic acid), azelaic acid (nonanedioic acid), sebacic acid (decanedioic acid), undecanedioic acid, dodecanedioic acid, pyridine-2,6-dicarboxylic acid, 1H-imidazole-4,5-dicarboxylic acid, furan-2,5-dicarboxylic acid, furan-2,3-dicarboxylic acid, thiophene-2,5-dicarboxylic acid, thiophene-2,3-dicarboxylic acid, quinoline-2,4-dicarboxylic acid, cyclohexane-1,4-dicarboxylic acid, cyclopentane-1,3-dicarboxylic acid, cyclobutane-1,3-dicarboxylic acid, or bicyclo[2.2.2]octane-1,4-dicarboxylic acid, or a bifunctional compound such as

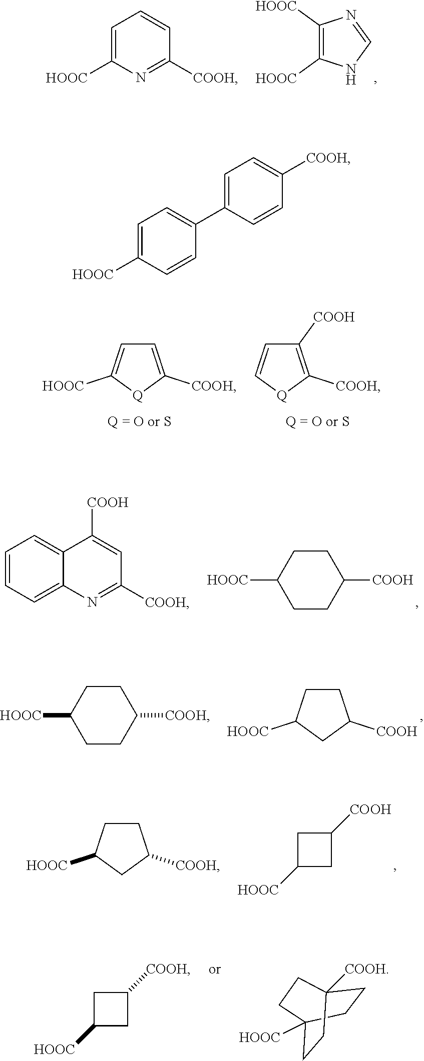

These and other features and characteristics are more particularly described below.

### BRIEF DESCRIPTION OF THE DRAWINGS

FIG. 1A-1B are images of the pCBDT electrochromic device in bleached state (left image FIG. 1A) and reduced state (right image FIG. 1B, where the polymer exhibits an indigo color).

FIG. 2 illustrates cyclic voltammetry of pCBDT in 0.1M TBAPF₆ Acetonitrile with a Ag/Ag+ reference electrode. Ferrocene is included as an internal reference.

FIG. 3 illustrates the absorbance spectra of pCBDT electrochromic device switched from 0 V (bleached; dashed line) to −4.4 V (colored; solid line).

FIG. 4 illustrates bandgap vs. glass transition plot for various commercial polymers and PCBDT (dashed line indicates the inverse relationship).

FIG. 5 illustrates variation of water contact angle to the glass transition temperature of different commercially available thermoplastic polymers and PCBDT.

FIG. 6 Compression isotherm (left) and corresponding Brewster angle microscopy images (right) for PCBDT monolayers.

FIG. 7A-7D: PCBDT monolayers, 7A SP=0.15 mN/m (1 min after spreading), 7B SP=0.13 mN/m (3 min after spreading), 7C SP=2 mN/m (170 Å2), and 7D SP=8 mN/m (140 Å2).

FIG. 8 illustrates discharged energy density and charge-discharge efficiency of PET and PCBDT at room temperature.

FIG. 9 illustrates discharged energy density and charge-discharge efficiency of PET and PCBDT at 100° C.

FIG. 10 illustrates Weibull distribution analysis of the breakdown strength of PCBDT and PET.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

Disclosed herein are compositions of polycannabinoids which find use in a number of applications as commodity polymers and for commodity electronics.

Polycannabinoids and polycannabinoid compositions described herein are new materials that are naturally biodegradable and may be tuned to exhibit a variety of properties, they are inexpensive to produce, and find use in a variety of applications and in the fabrication of a variety of devices. Non-limiting examples of uses of these polycannabinoids and polycannabinoid compositions include paints and coatings; dielectric materials; electrochromic materials; and other applications. Each application is discussed in further detail herein.

### Cannabinoid Polymers

Oils extracted from the hemp plant are called cannabinoids. Cannabinoids that have two hydroxyl groups, called diol cannabinoids, can be polymerized with dicarboxylic acids to create a polymer. The condensation reaction between the hydroxyl and carboxylic acid groups creates an ester bond that is degradable in the presence of water. Consequently, poly(cannabinoids) are biodegradable. The large number of cannabinoid monomers (>10) and dicarboxylic acids (>100) means that there are a large number of polymer structures.

In contrast to the monomers used to create most other bio-derived polyesters, cannabinoid monomers have ring structures that provide radical scavenging and antioxidant properties. After polymerization to form poly(cannabinoids), the ring structures in the monomers modify the interpolymer interactions to allow a large range of mechanical properties.

In one aspect, a polycannabinoid polymer comprises a plurality of cannabinoid units, specifically phytocannabinoid units. As used herein the term “Cannabinoid polymer(s)” and “polycannabinoid(s)” refer to a polymer comprising plurality of cannabinoid units.

In certain embodiments, the cannabinoid polymer is a polymer comprising a plurality of cannabinoid units of the formula:

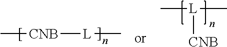

wherein:
CNB is a cannabinoid unit,
L is a linking group; and
n represents the number of repeat units wherein n is at least 2.

The cannabinoid units may be the same or different. In certain embodiments, each cannabinoid unit is independently CBG, CBD, CBC, CBND, DHCBD, CBG-R, CBD-R, CBC-R, CBND-R, DHCBD-R wherein the cannabinoid unit is bound to the linking group via hydroxyl groups, acid groups, or ester groups on the cannabinoid unit before polymerization. Additional cannabinoids and cannabinoid derivatives can be found, for example, in Morales P, Reggio P H and Jagerovic N (2017) An Overview on Medicinal Chemistry of Synthetic and Natural Derivatives of Cannabidiol. Front. Pharmacol. 8:422, the contents of which are incorporated herein in their entirety by reference.

| Cannabinoid | |
|---|---|
| Abbreviation | Cannabinoid |
| CBC | cannabichromene |
| CBC-R | substituted cannabichromene |
| CBD | cannabidiol |
| CBD-R | substituted cannabidiol |
| CBG | cannabigerol |
| CBG-R | substituted cannabigerol |
| DHCBD | dihydrocannabidiol |
| DHCBD -R | substituted dihydrocannabidiol |
| CBND | cannabinodiol |
| CBND-R | substituted cannabinodiol |
| THCA | Tetrahydrocannabinolic acid |

In certain embodiments, each cannabinoid unit may be the same or different and each has one of the following structures before polymerization, wherein the R group is C₁-C₁₀ alkyl optionally substituted with one or more heteroatoms, a heterocycloalkyl group, or a heteroaryl group, specifically C₁-C₆ alkyl, and more specifically n-pentyl or n-propyl; for the naturally occurring phytocannabinoids like CBD and CBG, R=methyl, ethyl, propyl, butyl, pentyl, hexyl, 4′-(3-carboxypropyl)-, 4′-(4-hydroxybutyl), 1,1-dimethylheptyl, 4′-[2-(1H-1,2,3-triazol-yl)ethyl]-, 4′-(2-morpholinoethyl)-, 4′-(2-ethoxyethyl)-:

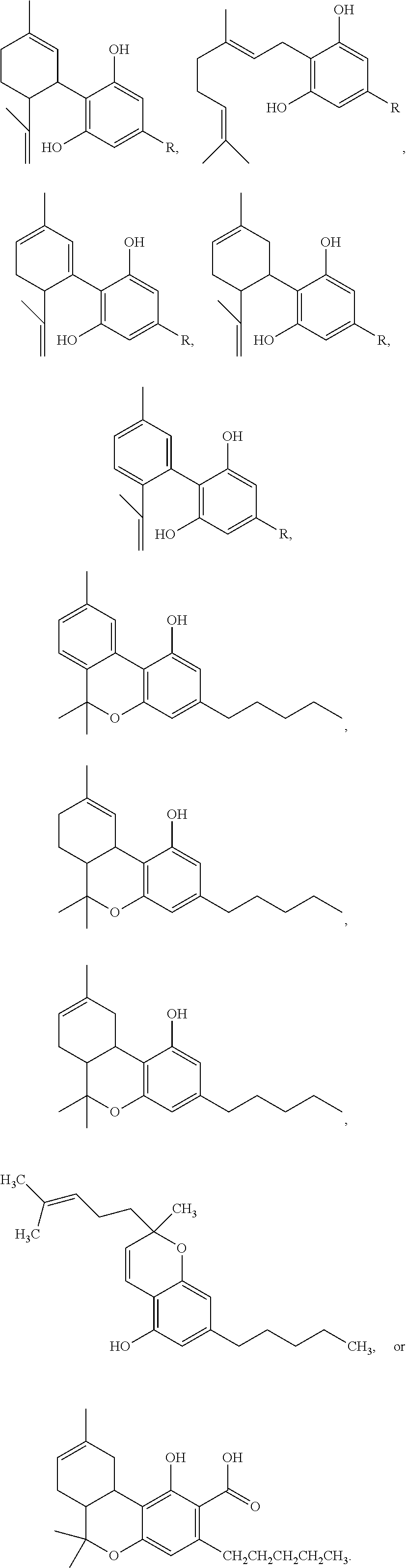

In certain embodiments, each cannabinoid unit may be the same or different and each has one of the following structures before polymerization:

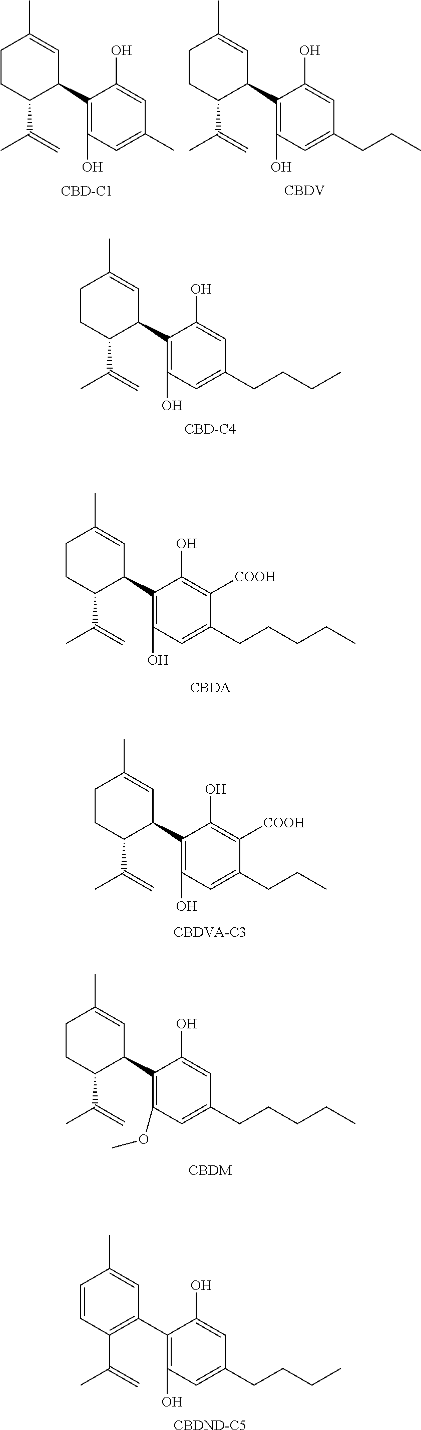

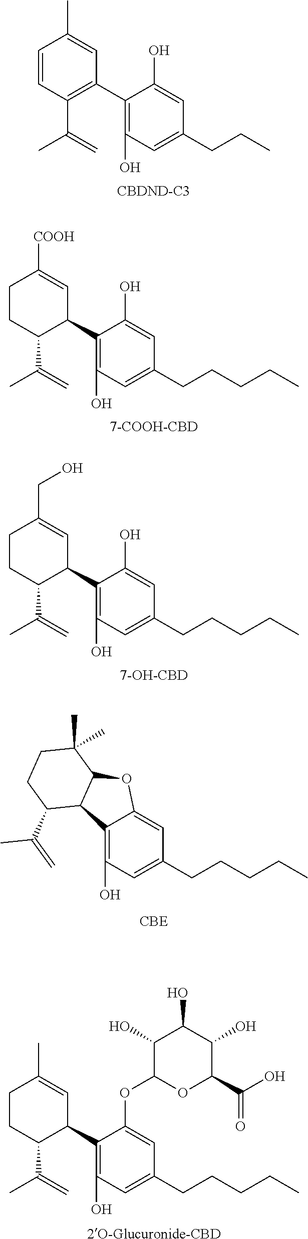

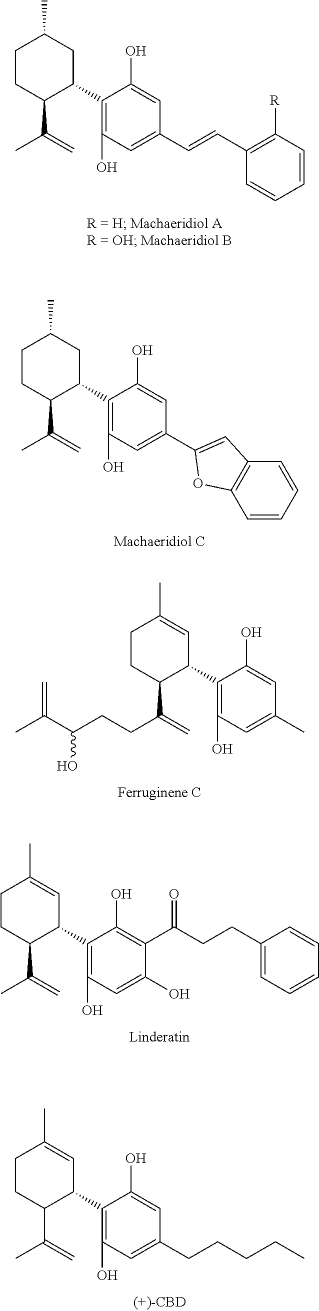

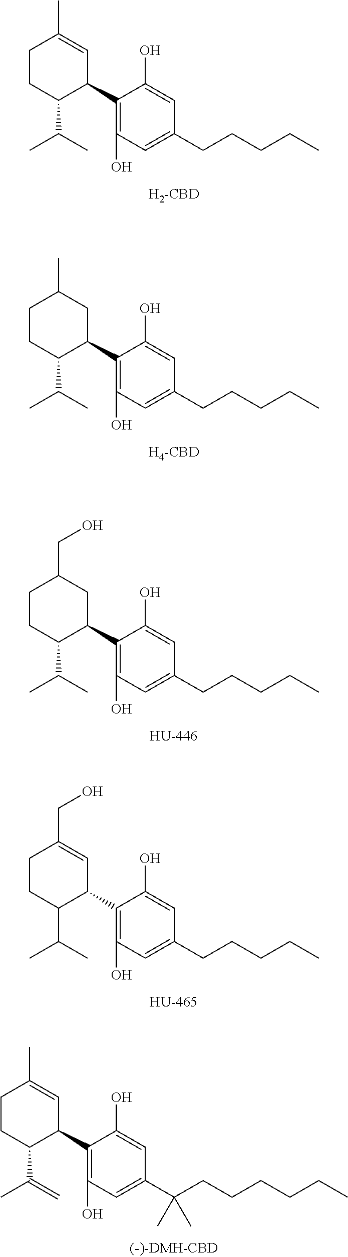 [SMILES: CCCCCc1cc(O)c([C@@H]2C=C(C)CC[C@H]2C(C)C)c(O)c1 ; CCCCCc1cc(O)c([C@@H]2CC(C)CC[C@H]2C(C)C)c(O)c1 ; CCCCCc1cc(O)c([C@@H]2CC(CO)CC[C@H]2C(C)C)c(O)c1 ; CCCCCc1cc(O)c([C@H]2C=C(CO)CCC2C(C)C)c(O)c1 ; C=C(C)[C@@H]1CCC(C)=C[C@H]1c1c(O)cc(C(C)(C)CCCCCC)cc1O]

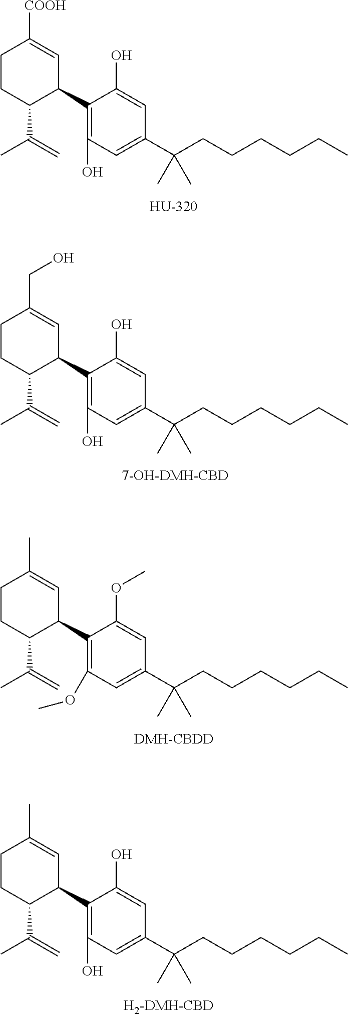 [SMILES: C=C(C)[C@@H]1CCC(C(=O)O)=C[C@H]1c1c(O)cc(C(C)(C)CCCCCC)cc1O ; C=C(C)[C@@H]1CCC(CO)=C[C@H]1c1c(O)cc(C(C)(C)CCCCCC)cc1O ; C=C(C)[C@@H]1CCC(C)=C[C@H]1c1c(OC)cc(C(C)(C)CCCCCC)cc1OC ; C=C(C)[C@@H]1CCC(C)=C[C@H]1c1c(O)cc(C(C)(C)CCCCCC)cc1O]

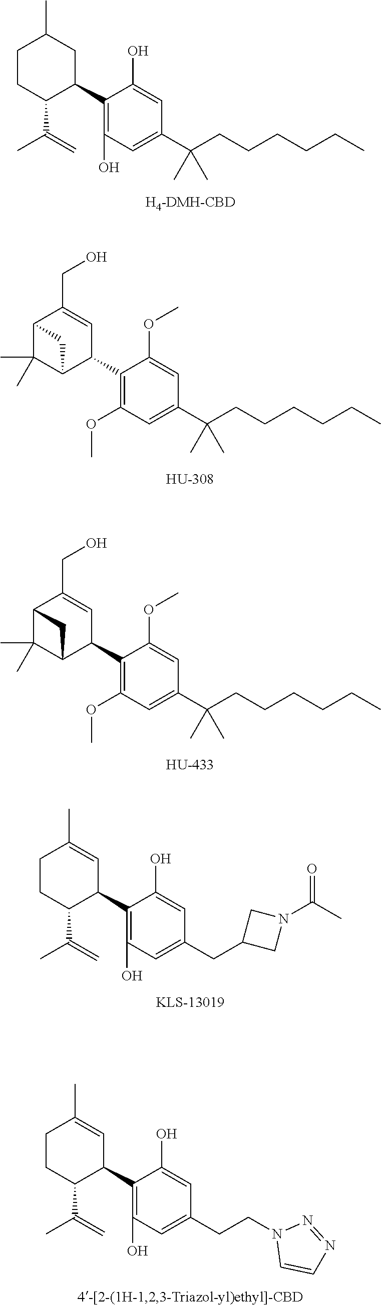

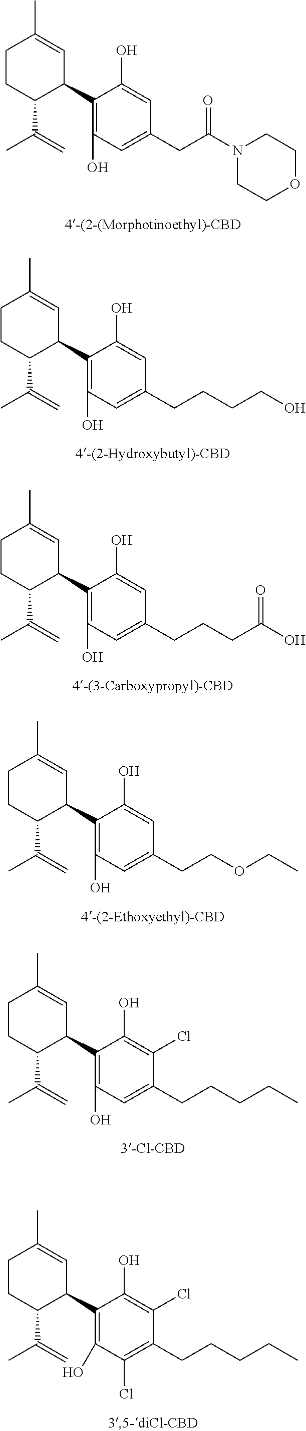 [SMILES: C=C(C)[C@@H]1CCC(C)=C[C@H]1c1c(O)cc(CC(=O)N2CCOCC2)cc1O ; C=C(C)[C@@H]1CCC(C)=C[C@H]1c1c(O)cc(CCCCO)cc1O ; C=C(C)[C@@H]1CCC(C)=C[C@H]1c1c(O)cc(CCCC(=O)O)cc1O ; C=C(C)[C@@H]1CCC(C)=C[C@H]1c1c(O)cc(CCOCC)cc1O ; C=C(C)[C@@H]1CCC(C)=C[C@H]1c1c(O)cc(CCCCC)c(Cl)c1O ; C=C(C)[C@@H]1CCC(C)=C[C@H]1c1c(O)c(Cl)c(CCCCC)c(Cl)c1O]

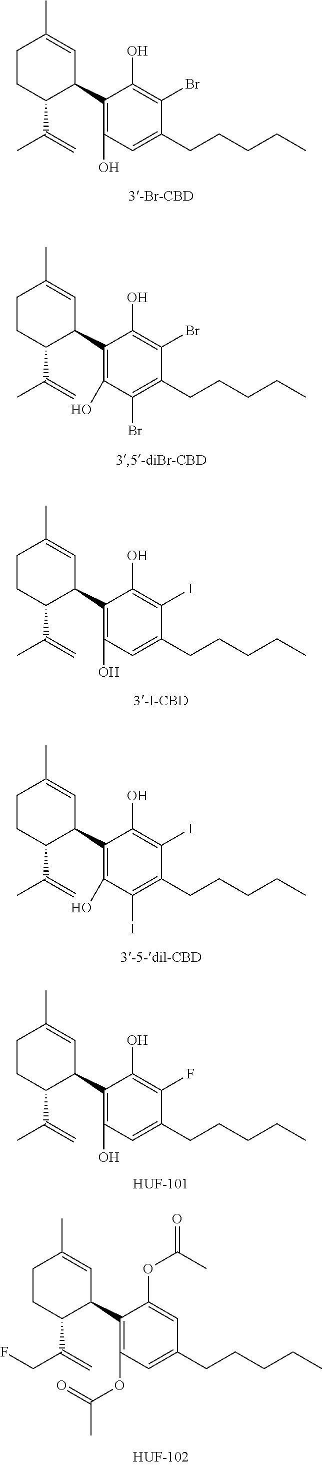 [SMILES: C=C(C)[C@@H]1CCC(C)=C[C@H]1c1c(O)cc(CCCCC)c(Br)c1O ; C=C(C)[C@@H]1CCC(C)=C[C@H]1c1c(O)c(Br)c(CCCCC)c(Br)c1O ; C=C(C)[C@@H]1CCC(C)=C[C@H]1c1c(O)cc(CCCCC)c(I)c1O ; C=C(C)[C@@H]1CCC(C)=C[C@H]1c1c(O)c(I)c(CCCCC)c(I)c1O ; C=C(C)[C@@H]1CCC(C)=C[C@H]1c1c(O)cc(CCCCC)c(F)c1O ; C=C(CF)[C@@H]1CCC(C)=C[C@H]1c1c(OC(C)=O)cc(CCCCC)cc1OC(C)=O]

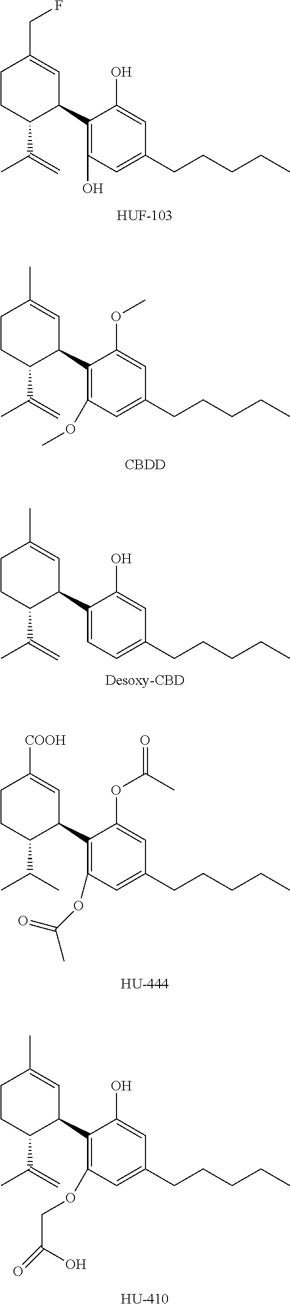

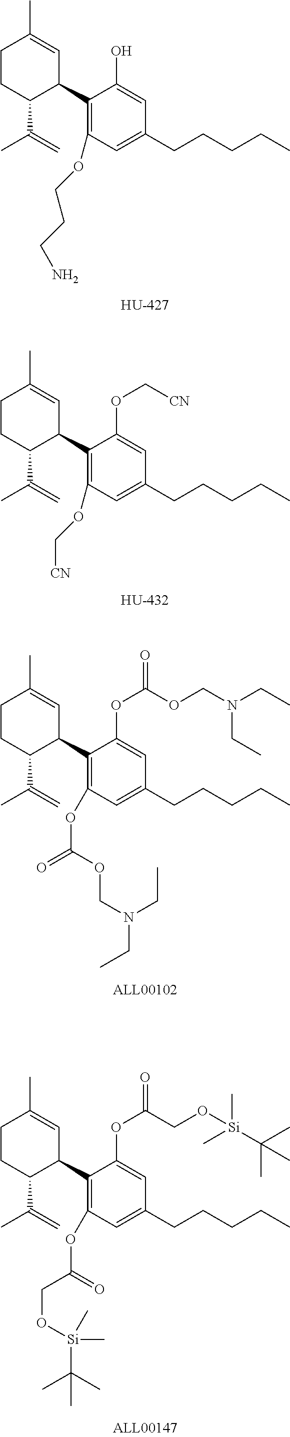 [SMILES: C=C(C)[C@@H]1CCC(C)=C[C@H]1c1c(O)cc(CCCCC)cc1OCCCN ; C=C(C)[C@@H]1CCC(C)=C[C@H]1c1c(OCC#N)cc(CCCCC)cc1OCC#N ; C=C(C)[C@@H]1CCC(C)=C[C@H]1c1c(OC(=O)OCN(CC)CC)cc(CCCCC)cc1OC(=O)OCN(CC)CC ; C=C(C)[C@@H]1CCC(C)=C[C@H]1c1c(OC(=O)CO[Si](C)(C)C(C)(C)C)cc(CCCCC)cc1OC(=O)CO[Si](C)(C)C(C)(C)C]

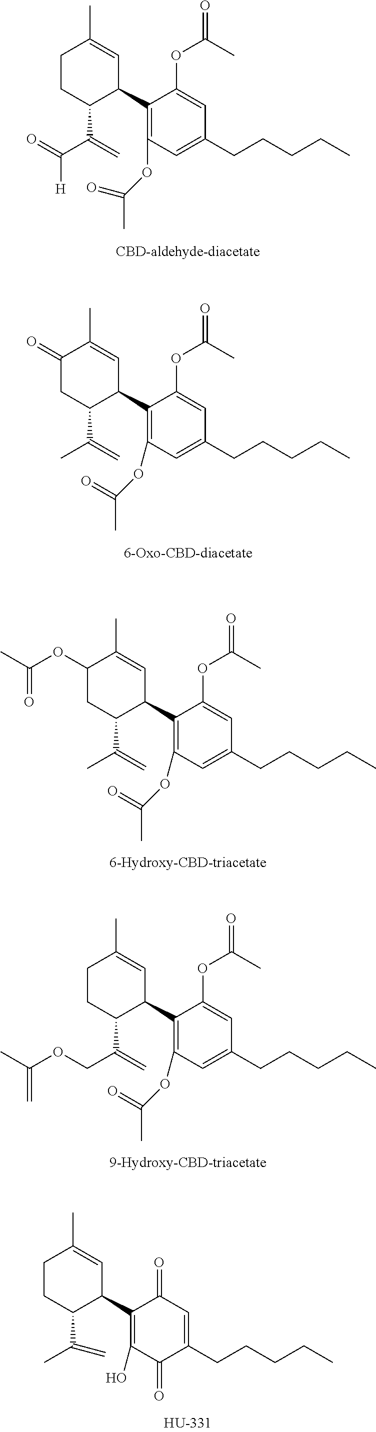

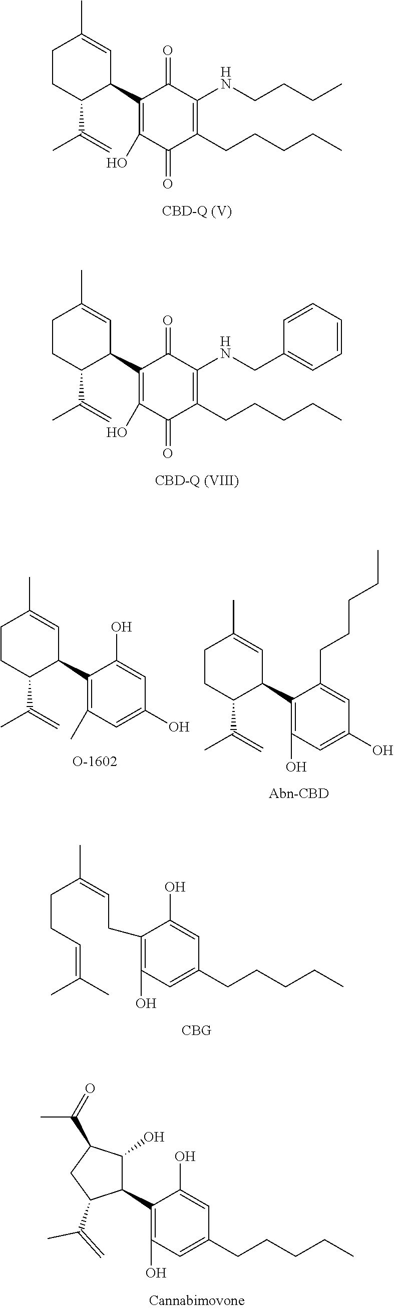

The polymer can be formed by reacting the hydroxyl or other reactive functionalities, such as the diacetate or similar esters made from the hydroxyls on the cannabinoid unit or cannabinoid derivative with an electrophilic difunctional comonomer to produce the linkers, L.

In certain embodiments, the linking group which generally binds the cannabinoid unit are via linear or branched hydrocarbon chains containing from 3 to 50 carbon atoms, optionally interrupted with one or more oxygen atoms, these chains can be alkyl, alkenyl or alkynyl chains containing from 3 to 50 carbon atoms, or else polyether chains containing from 3 to 50 carbon atoms, it being possible for these chains to be substituted with hydrophilic groups (hydroxyl groups, for example). The chains binding the cannabinoid units to one another contain at least 3 carbon atoms and specifically from 4 to 50 carbon atoms, the shortest path between two cannabinoid units specifically consisting of a chain containing between 3 and 8 carbon atoms.

Advantageously, the linking groups which link two cannabinoid units to one another may include linking groups of the general formula —O—(CH₂—CHOR¹—CH₂)ₘ—O—, where m is an integer between 1 and 50 (generally between 2 and 10) and where, in each of the n units (CH₂—CHOR¹—CH₂), R¹ denotes either a hydrogen atom or a —CH₂—CHOH—CH₂—O—chain bound to a cannabinoid unit of the polymer.

The polymers can be obtained by coupling cannabinoid molecules with bifunctional compounds capable of forming covalent bonds with the hydroxyl groups of the cannabinoid. For example, they may be dicarboxylic acids such as citric acid, fumaric acid, glutamic acid, maleic acid, malic acid, terephthalic acid, isophthalic acid, naphthalene-2,6-dicarboxylic acid, oxaloacetic acid, phthalic acid, butanedioic acid, oxalic acid, malonic acid, succinic acid, glutaric acid, adipic acid, pimelic acid (heptanedioic acid), suberic acid (octanedioic acid), azelaic acid (nonanedioic acid), sebacic acid (decanedioic acid), undecanedioic acid, dodecanedioic acid, pyridine-2,6-dicarboxylic acid, 1H-imidazole-4,5-dicarboxylic acid, furan-2,5-dicarboxylic acid, furan-2,3-dicarboxylic acid, thiophene-2,5-dicarboxylic acid, thiophene-2,3-dicarboxylic acid, quinoline-2,4-dicarboxylic acid, cyclohexane-1,4-dicarboxylic acid, cyclopentane-1,3-dicarboxylic acid, cyclobutane-1,3-dicarboxylic acid, or bicyclo[2.2.2]octane-1,4-dicarboxylic acid, or a bifunctional compound such as

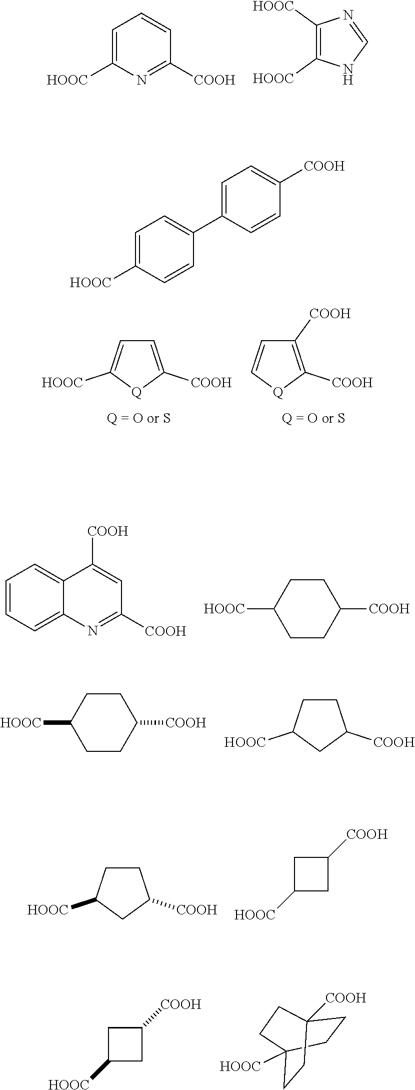

Known linking groups can be used. Representative specific examples of the linking groups are those monomers which polymerize to form vinyl polymers, polyurethanes, polyesters, polyethers, polyamides, polyimides, polyamino acids, polypeptides, polysaccharides, and the like. When the linking group is a vinyl monomer, specific examples of the vinyl polymer include (meth)acrylic monomers, styrene monomers, (meth)acrylamide monomers, ethylene monomers, propylene monomers, oxyethylene monomers, ethylene glycol monomers, propylene glycol monomers, monomers of vinyl alcohol, vinyl acetate monomers, vinyl chloride monomers, and the like. As used herein, (meth)acrylate refers to acrylate or methacrylate, and (meth)acrylic refers to methacrylic or acrylic.

Examples of (meth)acrylic monomers include (meth)acrylic acids and salts thereof, and (meth)acrylic acid esters such as methyl (meth)acrylate, ethyl (meth)acrylate, hydroxymethyl (meth)acrylate, and hydroxyethyl (meth)acrylate. Examples of styrene monomers include styrene, styrene sulfonates, and the like. Examples of (meth)acrylamide polymers include (meth)acrylamides, and (meth)acrylamide derivatives such as dimethyl (meth)acrylamide, diethyl (meth)acrylamide, N-isopropylacrylamide, and N-benzylacrylamide. The linking group monomers are not limited to those mentioned above as examples. Conventionally known vinyl monomers are also usable.

The cannabinoid polymer may be a homopolymer, or a copolymer obtained by copolymerizing monomers. When the cannabinoid polymer is a copolymer with one or more additional polymers, the additional polymers may be any of random copolymers, alternating copolymers, graft copolymers, or block copolymers. The side chain of the additional polymers may be substituted with a functional group. That is, as long the desired effect of the cannabinoid polymer is not impaired, the main chain and side chains of the additional polymers may be modified with other substituents by chemical bonds or the like.

In certain embodiments, the cannabinoid monomer can be incorporated into a thermoplastic polymer or a biodegradeable polymer.

Suitable thermoplastic polymers include, but are not limited to polylactides, polyglycolides, polycaprolactones, polyanhydrides, polyamides, polyurethanes, polyesteramides, polyorthoesters, polydioxanones, polyacetals, polyketals, polycarbonates, polyorthocarbonates, polyphosphazenes, polyhydroxybutyrates, polyhydroxyvalerates, polyalkylene oxalates, polyalkylene succinates, poly(malic acid) polymers, polymaleic anhydrides, poly(methylvinyl) ethers, poly(amino acids), chitin, chitosan, polythiocarbonates, polythiourethanes, and copolymers, terpolymers, or combinations or mixtures of the above materials.

Examples of biodegradable polymers and oligomers suitable for use in the compositions and methods include, but are not limited to, poly(lactide)s; poly(glycolide)s; poly(lactide-co-glycolide)s; poly(lactic acid)s; poly(glycolic acid)s; and poly(lactic acid-co-glycolic acid)s; poly(caprolactone)s; poly(malic acid)s; polyamides; polyanhydrides; polyamino acids; polyorthoesters; polyetheresters; polycyanoacrylates; polyphosphazines; polyphosphoesters; polyesteramides; polydioxanones; polyacetals; polyketals; polycarbonates; polyorthocarbonates; degradable polyurethanes; polyhydroxybutyrates; polyhydroxyvalerates; polyalkylene oxalates; polyalkylene succinates; chitins; chitosans; oxidized celluloses; and copolymers, terpolymers, blends, combinations or mixtures of any of the above materials.

As used herein, “hydrophobic” refers to a polymer that is substantially not soluble in water. As used herein, “hydrophilic” refers to a polymer that may be water-soluble or to a polymer having affinity for absorbing water, but typically not when covalently linked to the hydrophobic component as a co-polymer, and which attracts water into the device.

The cannabinoid unit can be incorporated into hydrophilic polymers. Hydrophilic polymers suitable for use herein can be obtained from various commercial, natural or synthetic sources well known in the art. Suitable hydrophilic polymers include, but are not limited to: polyanions including anionic polysaccharides such as alginate; agarose; heparin; polyacrylic acid salts; polymethacrylic acid salts; ethylene maleic anhydride copolymer (half ester); carboxymethyl amylose; carboxymethyl cellulose; carboxymethyl dextran; carboxymethyl starch; carboxymethyl chitin/chitosan; carboxy cellulose; 2,3-dicarboxycellulose; tricarboxycellulose; carboxy gum arabic; carboxy carrageenan; carboxy pectin; carboxy tragacanth gum; carboxy xanthan gum; carboxy guar gum; carboxy starch; pentosan polysulfate; curdlan; inositol hexasulfate; beta-cyclodextrin sulfate; hyaluronic acid; chondroitin-6-sulfate; dermatan sulfate; dextran sulfate; heparin sulfate; carrageenan; polygalacturonate; polyphosphate; polyaldehyde-carbonic acid; poly-1-hydroxy-1-sulfonate-propen-2; copolystyrene maleic acid; mesoglycan; sulfopropylated polyvinyl alcohols; cellulose sulfate; protamine sulfate; phospho guar gum; polyglutamic acid; polyaspartic acid; polyamino acids; and any derivatives or combinations thereof. One skilled in the art will appreciate other hydrophilic polymers can also be used.

The cannabinoid unit can be incorporated into various water-soluble polymers. Water-soluble polymers include, but are not limited to: poly (alkyleneglycol), polyethylene glycol (“PEG”); propylene glycol; ethylene glycol/propylene glycol copolymers; carboxylmethylcellulose; dextran; polyvinyl alcohol (“PVOH”); polyvinyl pyrolidone; poly (alkyleneamine)s; poly (alkyleneoxide)s; poly-1,3-dioxolane; poly-1,3,6-trioxane; ethylene/maleic anhydride copolymers; polyaminoacids; poly (n-vinyl pyrolidone); polypropylene oxide/ethylene oxide copolymers; polyoxyethylated polyols; polyvinyl alcohol succinate; glycerine; ethylene oxides; propylene oxides; poloxamers; alkoxylated copolymers; water soluble polyanions; and any derivatives or combinations thereof. In addition, the water-soluble polymer may be of any suitable molecular weight and may be branched or unbranched.

In certain embodiments, the cannabinoid polymers can be endcapped with a suitable monomer having a singularly reactive monomer. The endcap can be any group which does not alter the polymer properties or reduce the efficacy of the cannabinoid units. In particular embodiments, the endcap groups can be, independently, a linear or branched alcohol, or a singly reactive cannabinoid unit, for example, a cannabinoid unit having only one hydroxy group, one acid group, or one ester group. In certain embodiments, the endcap may have additional reactive cites which are protected during the reaction with the polymer and are later deprotected to provide additional reactive functionality to the polymer. In certain embodiments, each singly reactive cannabinoid unit has the structure:

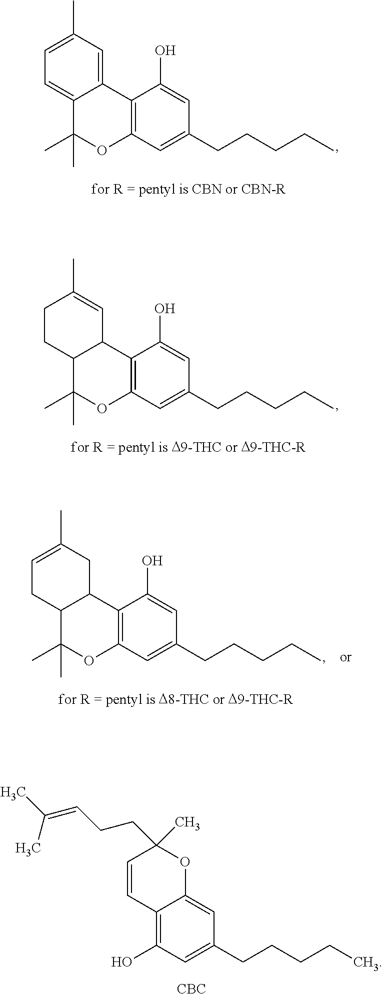

In general. the cannabinoid polymers have a number average molecular weight of about 1,000 daltons to about 60,000 daltons. In certain embodiment, the cannabinoid polymers has a number average molecular weight of about 5,000 daltons to about 55,000 daltons, a number average molecular weight of about 6,000 daltons to about 50,000 daltons, a number average molecular weight of about 7,000 daltons to about 50,000 daltons, a number average molecular weight of about 9,000 to about 40,000 daltons, or a number average molecular weight of about 10,000 to about 30,000 daltons.

The particular process to be utilized in the preparation of the cannabinoid polymers depends upon the specific polymers desired. Such factors as the selection of the specific substituents play a role in the path to be followed in the preparation of the specific compounds. Those factors are readily recognized by one of ordinary skill in the art.

The cannabinoid polymers may be prepared by use of known chemical reactions and procedures. Nevertheless, the following general preparative methods are presented to aid the reader in synthesizing the compounds, with more detailed particular examples being presented below in the experimental section describing the working examples.

The cannabinoid polymers can be made according to conventional chemical methods, and/or as disclosed below, from starting materials which are either commercially available or producible according to routine, conventional chemical methods. General methods for the preparation of the compounds are given below, and the preparation of representative compounds is specifically illustrated in examples.

Exemplary general methods to make cannabinoid polymers described herein are illustrated in Reaction Schemes 1-4.

The cannabinoid polymers may be formed by solventless procedures (e.g. melt polymerizations) as well as those employing solvent including combinations of pure monomers if both are liquids (includes the melting of CBD or other cannabinoid to form a liquid, alternatively, the polymerization can be carried out in a solvent) or by interfacial polymerization.

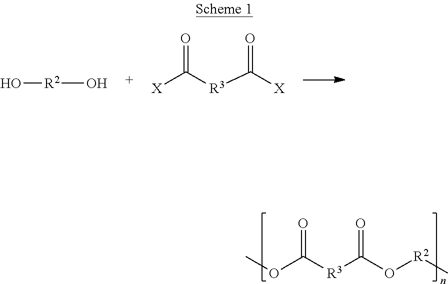

Scheme 1 presents a generic reaction scheme for the reaction of a cannabinoid diol monomer (HO-R²—OH) with a dicarbonyl monomer to produce a cannabinoid polyester. Equal equivalents of each will produce a high molecular weight polymer (Mn>20 kDa). The non-diol monomer could be a dicarboxylic acid, a diester, a dianhydride, a diacid chloride where X would be equal to —OH, O—R⁴, O—(C═O)—OR⁴ wherein R⁴ can be aliphatic, Cl, respectively. R³ could be aliphatic, branched aliphatic, halogenated (halogen includes fluorine, chlorine, bromine) aliphatic, halogenated branched aliphatic, aromatic, ethyleneoxy (linear or branched ether) or combinations thereof.

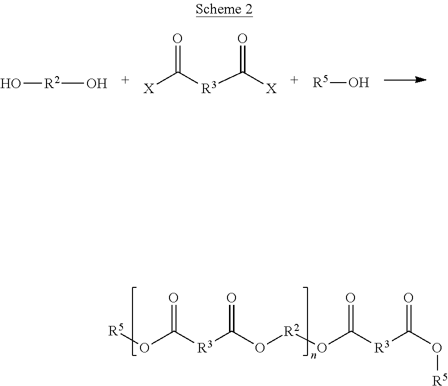

Scheme 2 presents a generic reaction scheme for the reaction of a cannabinoid diol monomer (HO-R²—OH) with a dicarbonyl monomer in the presence of a cannabinoid with single hydroxy (R⁵-OH) to produce a cannabinoid polyester with cannabinoid endcaps. Endcapping can control the molecule weight of the polymer and can control the ratio of the two cannabinoids. The non-diol monomer could be a dicarboxylic acid, a diester, a dianhydride, a diacid chloride where X would be equal to —OH, O—R⁴, O—(C═O)—OR⁴, Cl, respectively.

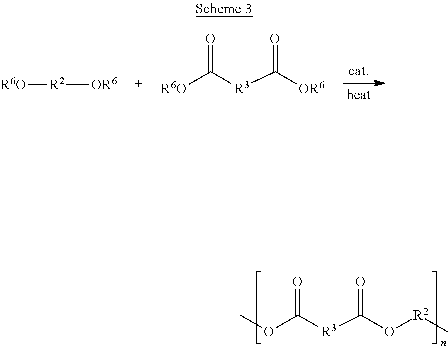

Scheme 3 shows a reaction in which diols are easily converted to (R⁶O-R²—OR⁶) a short ester such as a methyl or ethyl ester (R⁶=lower alkyl). The diester monomer can then be transesterified to produce a polyester.

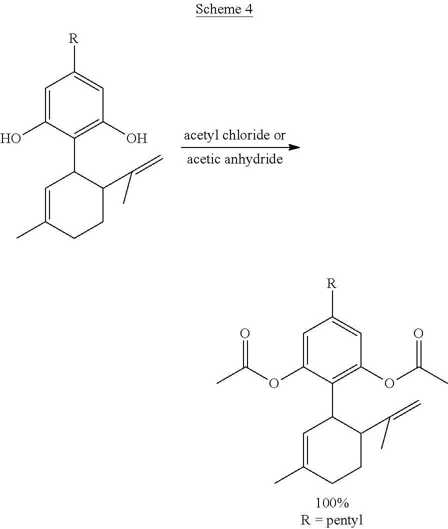

Scheme 4 shows, as a model for polymerization, CBD can be converted quantitatively to diacetyl CBD in accordance to the following reaction. Diacetyl CBD is a colorless liquid whereas CBD is a solid. Hence, diacetyl CBD can allow for a liquid phase polymerization without solvent with another monomer to produce a high molecular weight polymer. The other diols can undergo similar chemistry to make diacetyl monomers for transesterification.

The polycannabinoids can be altered by the type of polymer (polyester, polyurethane, polycarbonate) which will then alter the polymer properties. Flexibility in the backbone will result in low Tg materials that will be rubbery at room temperature whereas reducing the flexibility will increase the Tg making them a glassy solid. Cannabinoids have an exact stereochemistry, so polymerization with a symmetrical comonomer can produce semicrystalline polymers with the ability to be melt cast into films and fibers. Melt polymerization is also possible if the polymer generated is semicrystalline.

The cannabinoid polymers are thermally stable and stable against conversion of the target cannabinoid to another cannabinoid compound.

The use of aromatic diacids as the bifunctional compound to prepare the cannabinoid polymers impart rigidity to the polymer and the flat ring is important for morphology, stacking of rings. Aromatic bifunctional compounds containing pyridine and quinoline groups can catalyze the biodegradation of the polymer via ester hydrolysis as these groups are basic. Aromatic bifunctional compounds containing imidazole, which is both acidic and basic, provide a means to catalyze hydrolysis under both conditions.

The use of alicyclic groups provide rigidity but not at the cost of a lower bandgap. Furthermore, alicyclic groups do not display toxicities of compounds having benzene rings.

Aliphatic diacids as the bifunctional compound are expected to be soft segments in copolymers using aromatic or alicyclic diacids. The combination of hard and soft segments results in melt processable thermoplastic elastomers. Aliphatic diacids will generally have lower glass transition temperatures compared to homopolymer polycannabinoids containing ring groups.

Suitable homopolymers of cannabidiol (CBD) include the following.

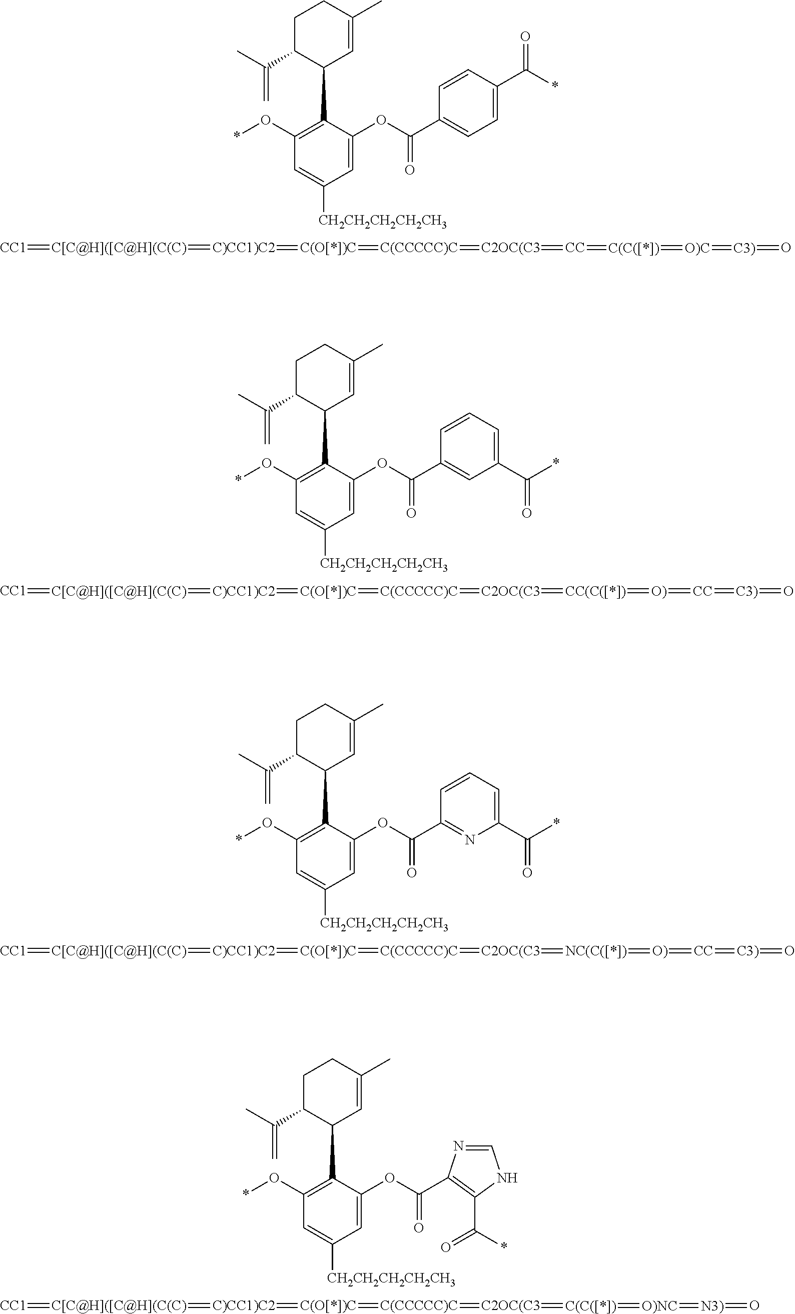

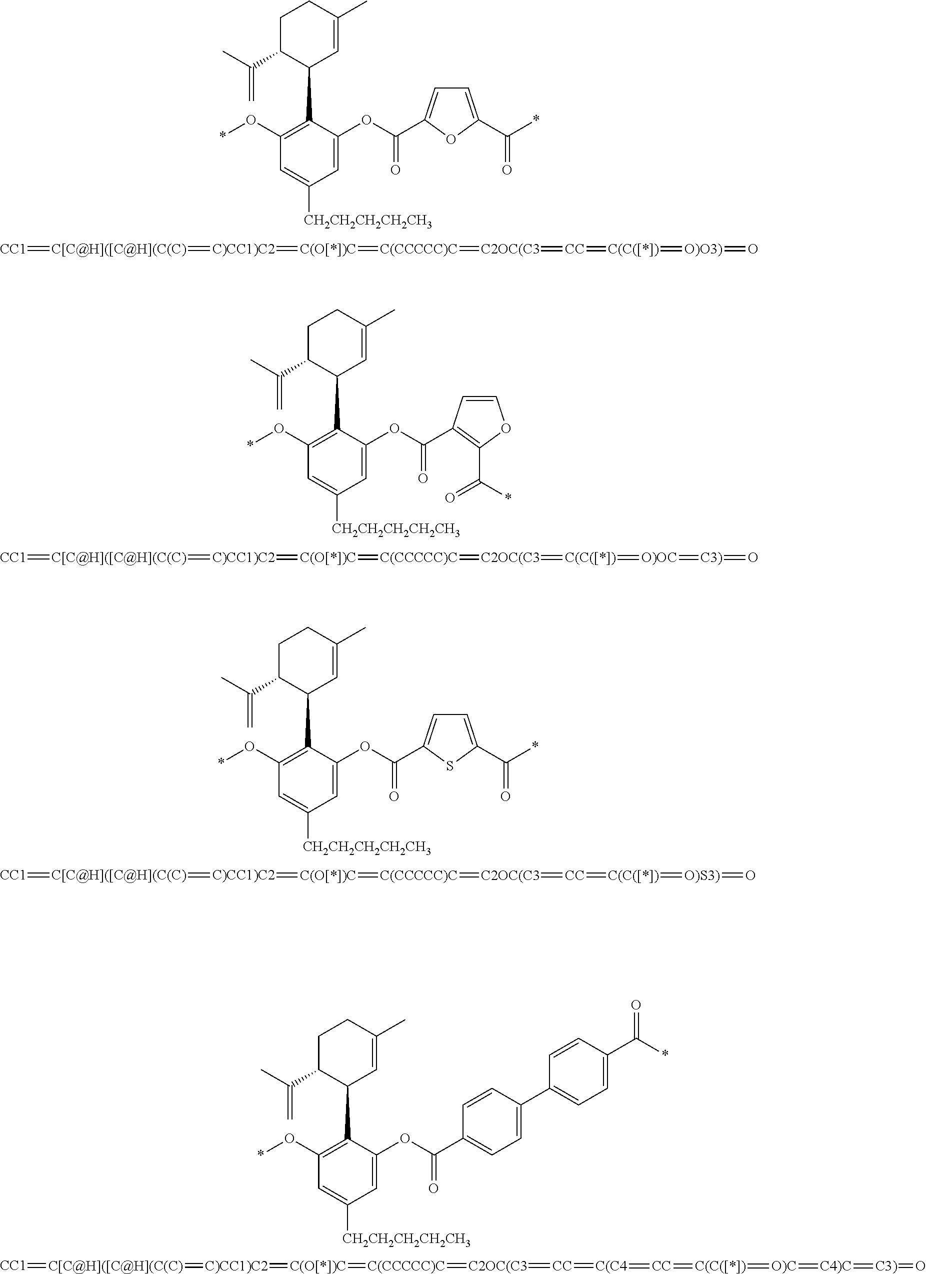

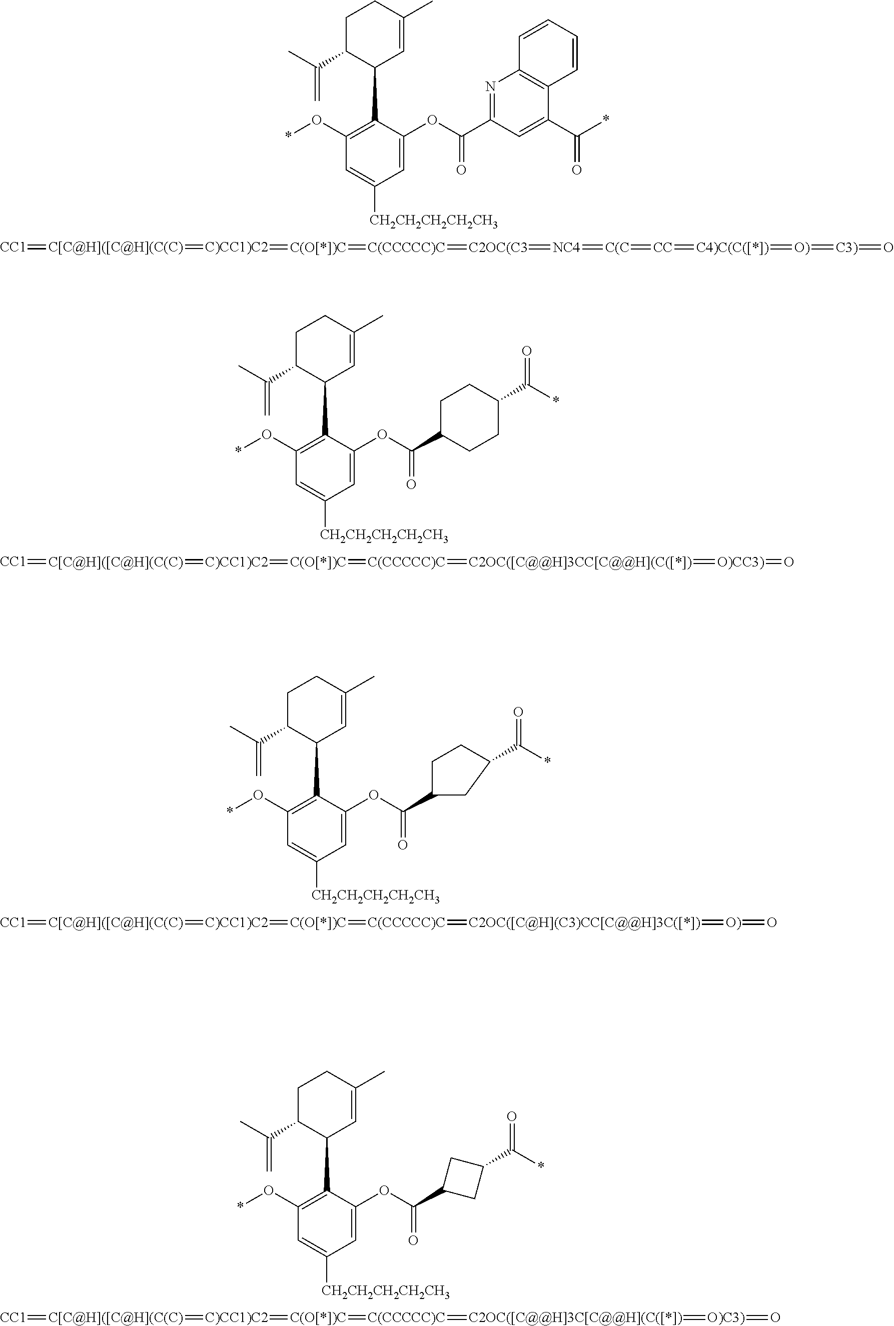

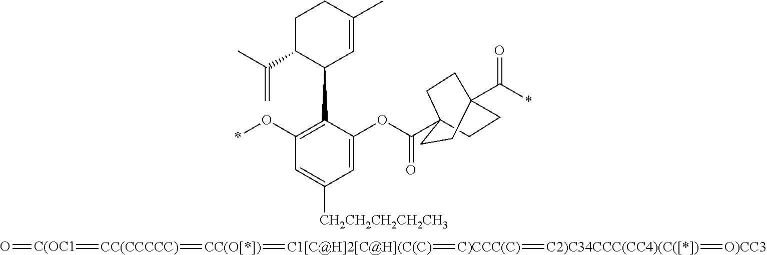

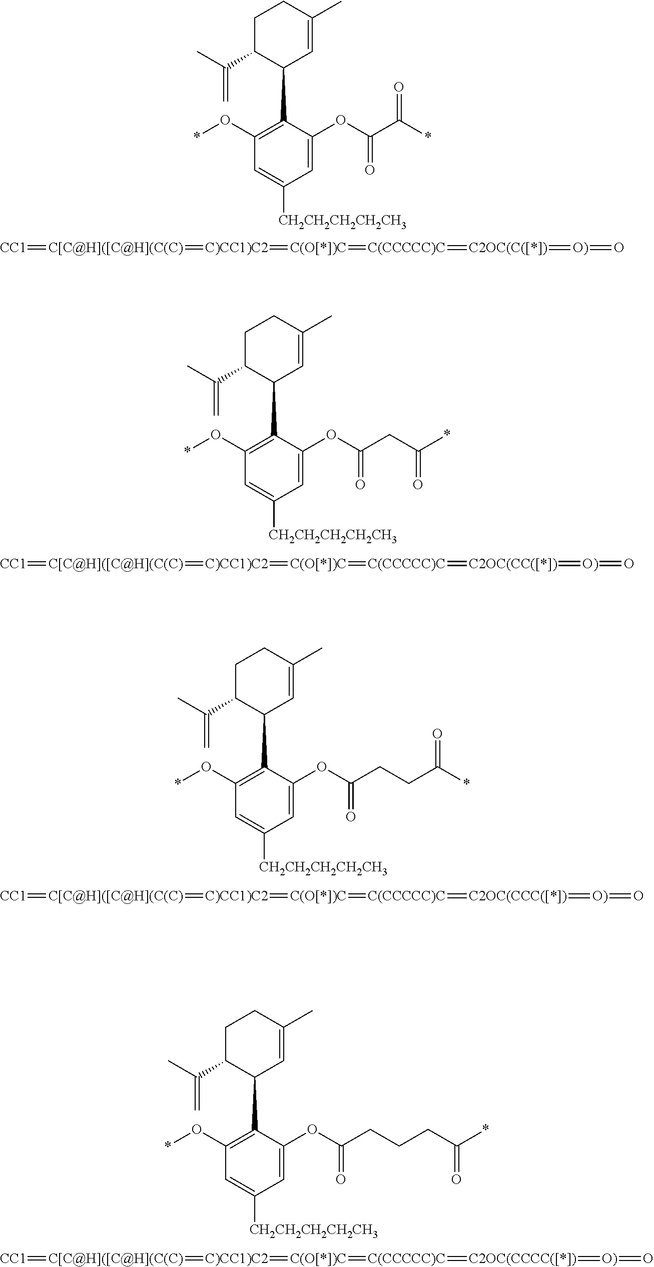

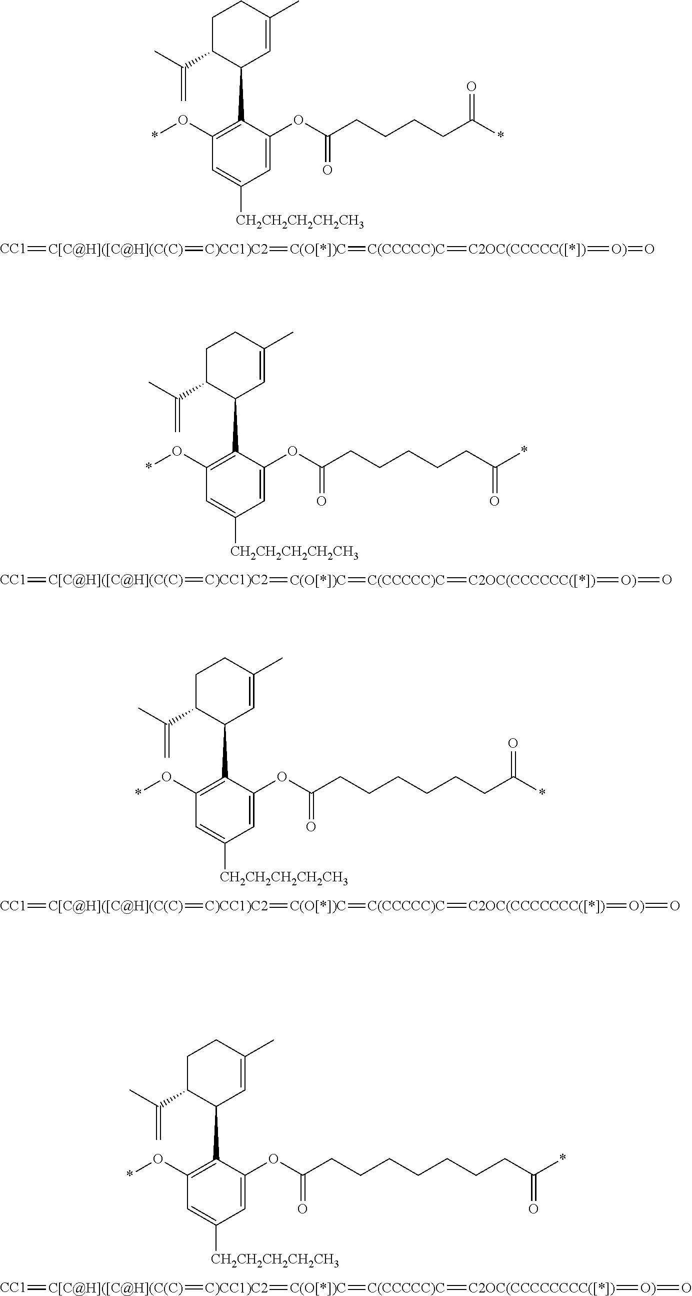

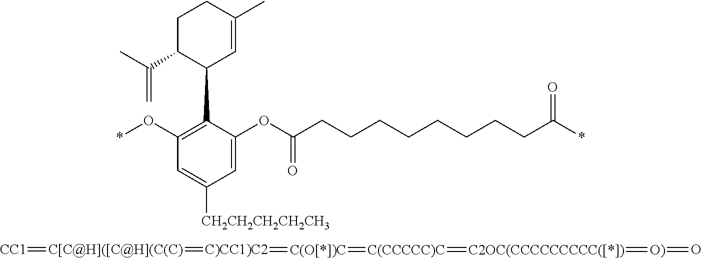

Suitable homopolymers of cannabigerol (CBG) include the following.

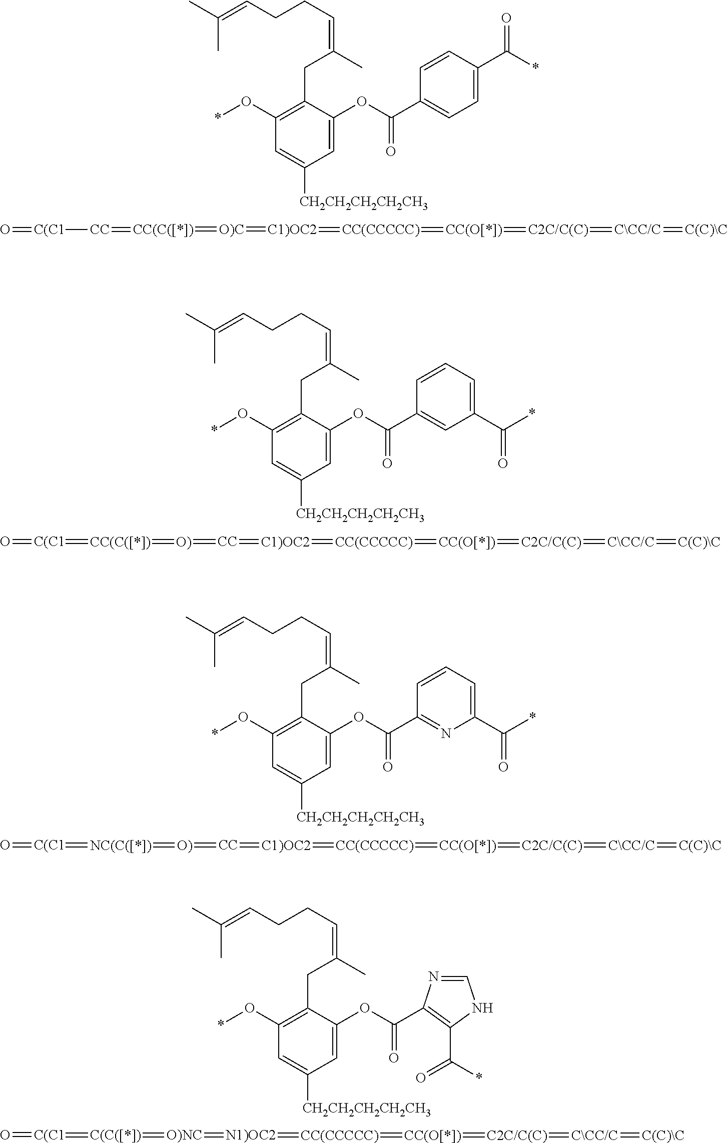

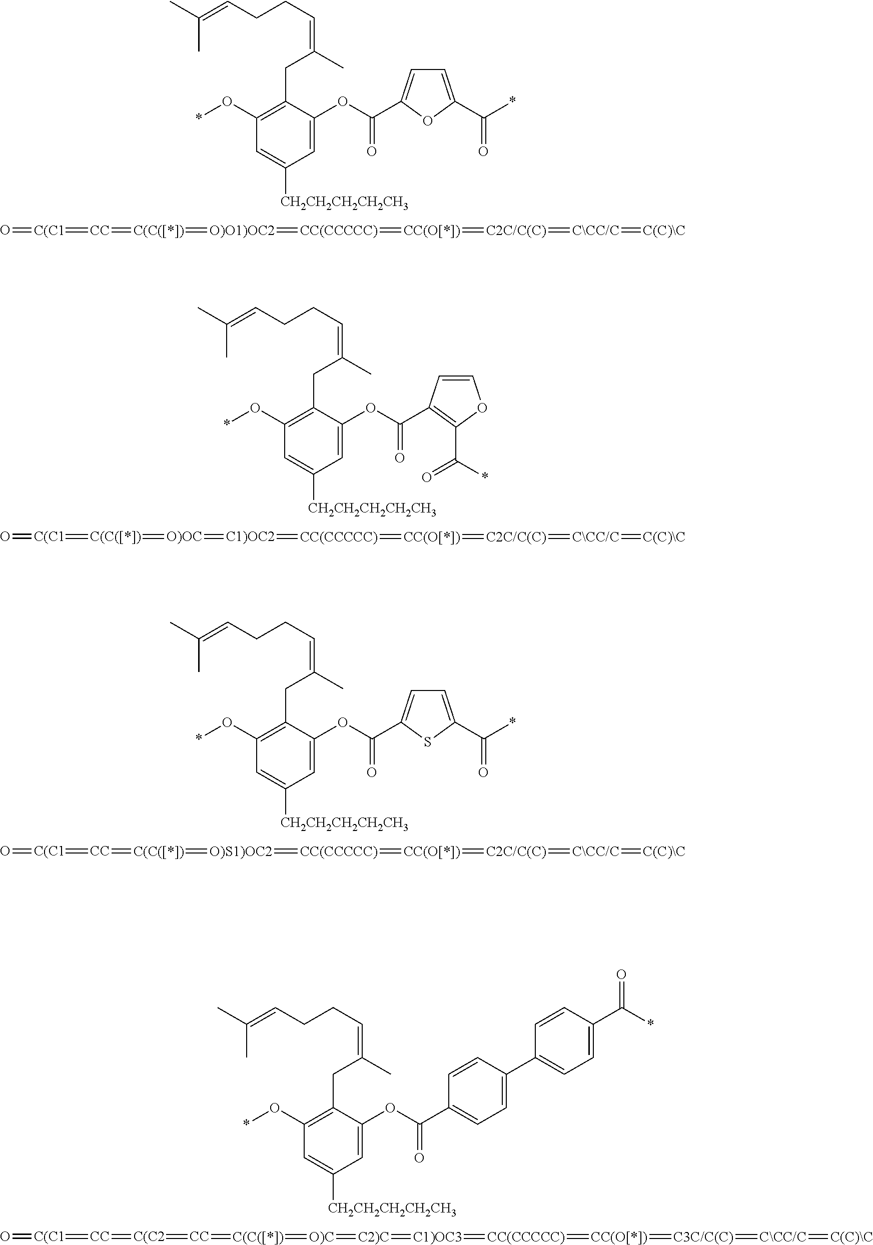

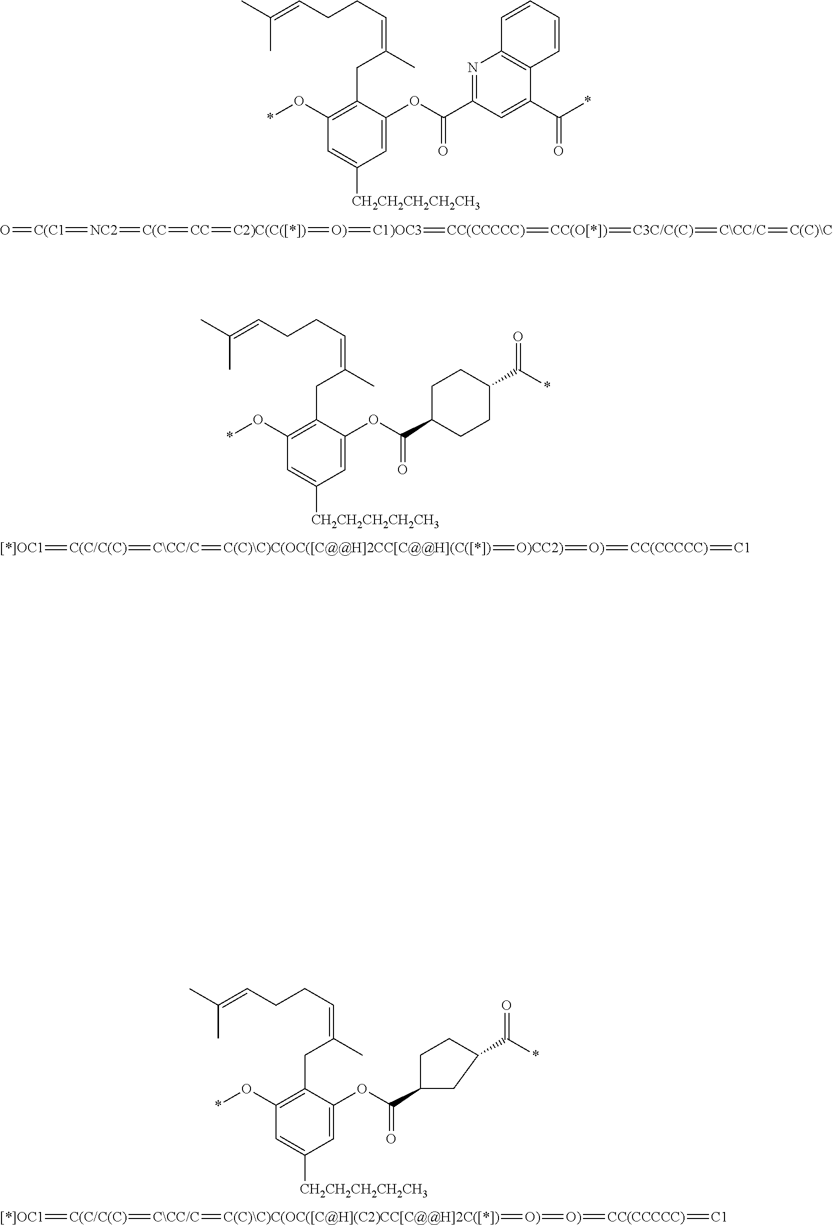

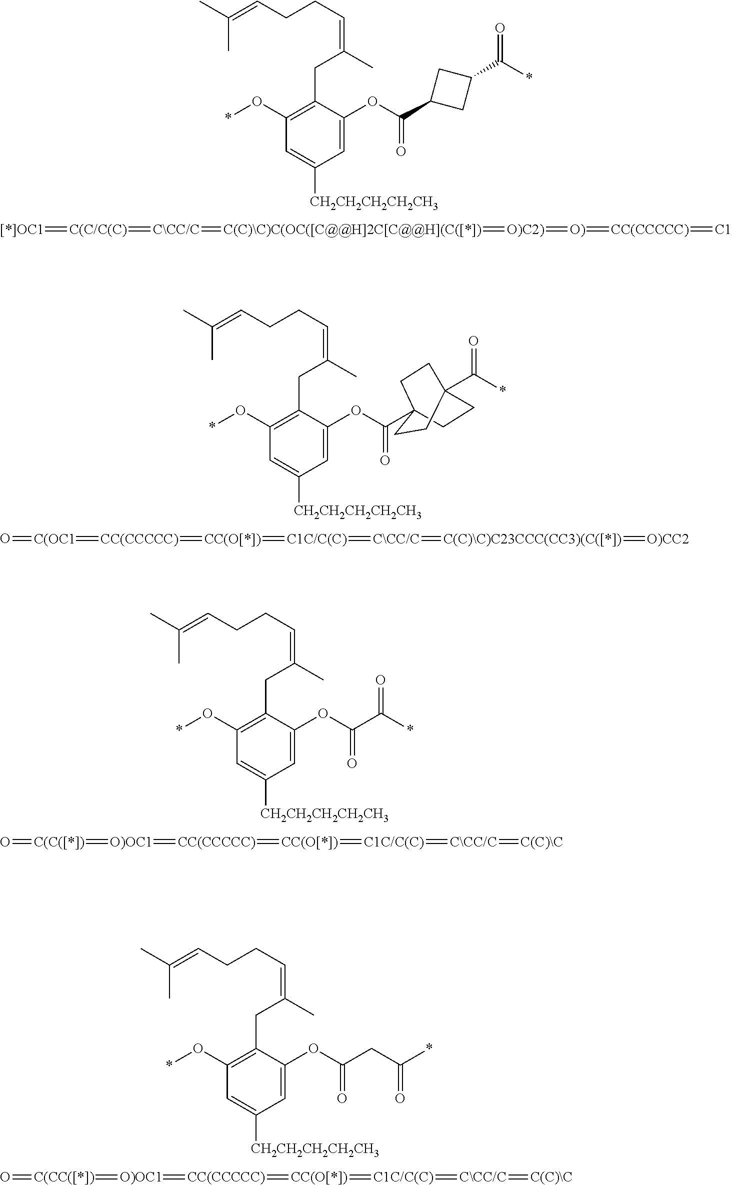

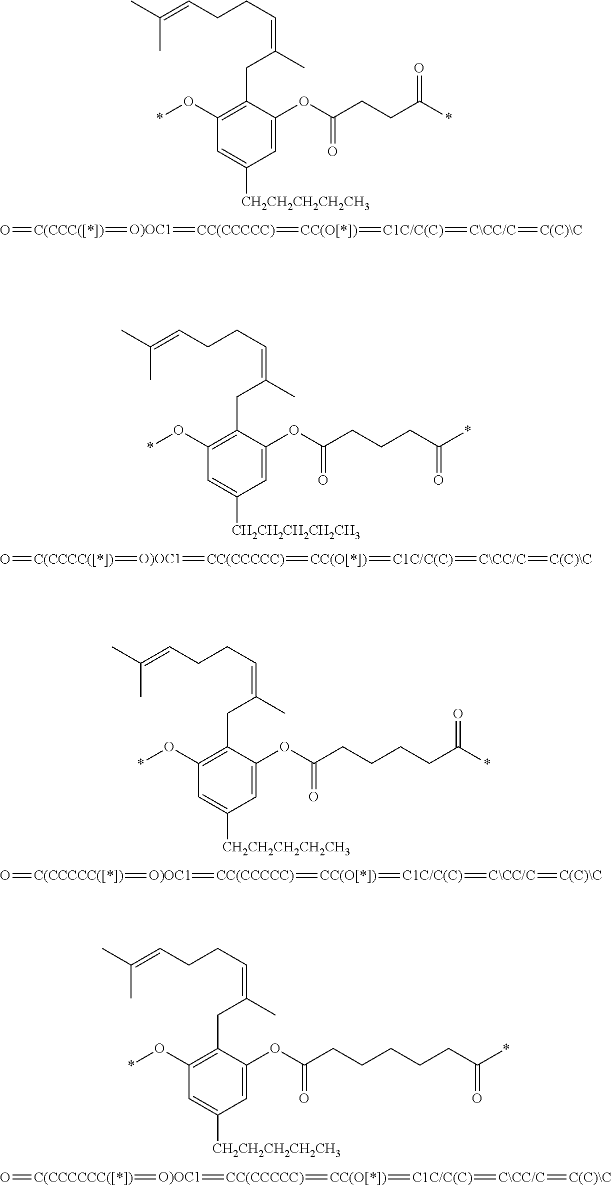

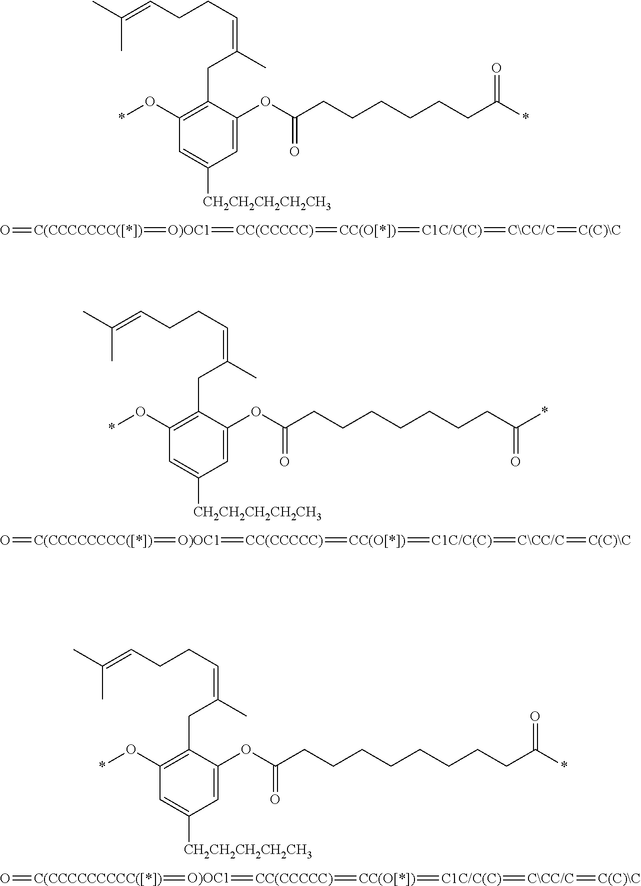

### Polycannabinoid Electrochromics

An electrochromic device is a self-contained, two-electrode (or more) electrolytic cell that includes an electrolyte and one or more electrochromic materials. In general, electrochromic materials can be organic or inorganic, and reversibly change visible color when oxidized or reduced in response to an applied electrical potential. Electrochromic devices are therefore constructed so as to modulate incident electromagnetic radiation via transmission, absorption, or reflection of the light upon the application of an electric field across the electrodes. The electrodes and electrochromic materials used in the devices are dependent on the type of device, i.e., absorptive/transmissive or absorptive/reflective.

Known electrochromic materials include inorganic materials such as indium-doped tin oxide (ITO) and fluorine-doped tin oxide (SnO₂:F), and organic conjugated polymers such as poly(3,4-ethylenedioxythiophene)-poly(styrene sulfonate) (PEDOT-PSS) and polyaniline. Drawbacks of electrochromic inorganic materials and conjugated polymers include processing limitations including their inability to be melt processed.

Disclosed herein are polycannabinoid electrochromic material compositions and electrochromic devices and articles comprising the electrochromic material compositions. The polycannabinoid can be a polymer as described above. Advantages of preparing electrochromics using polycannabinoids is that the polymers function as hydrophobic antioxidants, which can aid in stabilizing many device types; the polycannabinoids can be used to prepare naturally biodegradable displays; and cannabinoids include an aromatic ring, resulting in molecules that are chromophores and dielectrics. Polycannabinoid polymers can be prepared with innately electrochromic polymers such as PET/PEN.

In an embodiment, polycannabinoid electrochromic material composition comprises a polymer comprising units derived from a cannabinoid, units derived from difunctionalized aromatic groups, and optionally units derived from C₂-C₁₂ aliphatic groups. The polycannabinoid electrochromic material composition can further comprise a salt, a plasticizer, a solvent, or a combination thereof.

The polycannabinoid electrochromic can be prepared by esterification, thioesterification, or amidation of the starting dicarboxylic acid of the corresponding aromatic group, e.g., terephthalic acid (benzene-1,4-dicarboxylic acid), benzene-1,3-dicarboxylic acid, pyridine-2,5-dicarboxylic acid, naphthalene-2,6-dicarboxylic acid, 1,4-naphthalenedicarboxylic acid, and the like. Alternatively, the compounds can be prepared starting from an activated dicarboxylic acid of the corresponding aromatic group, including acid chlorides. In yet another alternative, the starting material can be a dicarboxylic acid ester group. Selection of the particular synthetic route can be made by one having ordinary skill in the art without undue experimentation.

Exemplary aromatic structures include phenyl; biphenyl; naphthyl; pyridyl; 4,4′-bipyridyl; 2,2′-bipyridyl; benzophenone; and the like, which can be prepared as dicarboxylic acids, and in turn, can be prepared as polyesters, specifically polymerized with a cannabinoid, or copolymerized with polyethylene naphthalate, polyethylene terephthalate, or both to produce electrochromic polymers of different colors.

In an embodiment, the polycannabinoid electrochromic material composition comprises a salt and a poly(cannabinoid terephthalate), a poly(cannabinoid naphthalate), or a combination thereof. Specifically the polycannabinoid electrochromic material composition comprises a salt and a poly(cannabidiol terephthalate), a poly(cannabidiol naphthalate), or a combination thereof.

Polyesters such as a poly(ethylene terephthalate) (PET), a poly(naphthalene terephthalate) (PEN), blends and copolymers thereof, and the like can be melt processed with a salt and exhibit electrochromic functionality. PET, when processed with an electrolyte, such as an ionic liquid, is an electrochromic polymer transitioning between colorless (neutral, zero charge) and pink (reduced state, radical anion). PEN exhibits better mechanical and thermal properties than PET. PEN, when processed with an electrolyte, such as an ionic liquid, is an electrochromic polymer transitioning between colorless (neutral, zero charge) and green (reduced state, radical anion).

The polycannabinoid electrochromic material compositions can be blended with PET, PEN, a PET-PEN copolymer, or a combination thereof. In alternative embodiment, copolymers of PET or PEN can be synthesized to comprise units of cannabinoids.

The salt can be present for electron transfer types of electrochromics. The salt of the electrochromic material composition may be a metal salt, an organic salt (e.g., ionic liquids), an inorganic salt, and the like, or a combination thereof. In an embodiment, the salt comprises an alkali metal ion of Li, Na, or K. Exemplary salts, where M represents an alkali metal ion, include MClO₄, MPF₆, MBF₄, MAsF₆, MSbF₆, MCF₃SO₃, MCF₃CO₂, M₂C₂F₄(SO₃)₂, MN(CF₃SO₂)₂, MN(C₂F₅SO₂)₂, MC(CF₃SO₂)₃, MCₙF₂ₙ₊₁SO₃ (2≤n≤3), MN(RfOSO₂)₂ (wherein Rf is a fluoroalkyl group), or a combination thereof. Exemplary lithium salts include lithium trifluoromethanesulfonate. Other suitable salts include tetra-n-butylammonium tetrafluoroborate (TBABF₄); tetra-n-butylammonium hexafluorophosphate (TBAPF₆); or a combination thereof.

The salt of the electrochromic material composition can be an ionic liquid. Ionic liquids are organic salts with melting points under about 100° C. Other ionic liquids have melting points of less than room temperature (˜22° C.). Examples of ionic liquids that may be used in the electrochromic material composition include imidazolium, pyridinium, phosphonium or tetralkylammonium based compounds, for example, 1-ethyl-3-methylimidazolium tosylate, 1-butyl-3-methylimidazolium octyl sulfate; 1-butyl-3-methylimidazolium 2-(2-methoxyethoxy)ethyl sulfate; 1-ethyl-3-methylimidazolium bis(pentafluoroethylsulfonyl)imide; 1-ethyl-3-methylimidazolium bis(trifluoromethylsulfonyl)imide; 1-ethyl-3-methylimidazolium bromide; 1-ethyl-3-methylimidazolium hexafluorophosphate; 1-butyl-3-methylimidazolium bromide; 1-butyl-3-methylimidazolium trifluoromethane sulfonate; 1,2-dimethyl-3-propylimidazolium tris(trifluoromethylsulfonyl)methide; 1,2-dimethyl-3-propylimidazolium bis(trifluoromethylsulfonyl)imide; 3-methyl-1-propylpyridinium bis(trifluormethylsulfonyl)imide; 1-butyl-3-methylpyridinium bis(trifluormethylsulfonyl)imide; 1-butyl-4-methylpyridinium chloride; 1-butyl-4-methylpyridinium hexafluorophosphate; 1-butyl-4-methylpyridinium tetrafluoroborate; 1-n-butyl-3-methylimidazolium hexafluorophosphate (n-BMIM PF₆); 1-butyl-3-methylimidazolium tetrafluoroborate (BMIM BF₄); phosphonium dodecylbenzenesulfonate; phosphonium methanesulfonate; or a combination thereof.

The salt may be present in the electrochromic material composition in an amount of about 5 to about 40 wt % of the total weight of salt, electrochromic material, and if used, plasticizer; specifically about 10 wt % to about 30 wt %, and more specifically 12 to about 17 wt % of salt, electrochromic material, and if used, plasticizer.

The electrochromic material composition may optionally further comprise a solvent or plasticizer. These may be high boiling organic liquids such as dialkyl phthalate for example dimethyl phthalate or diethyl phthalate, carbonates for example alkylene and alkylyne carbonates such as dimethyl carbonate, ethylmethyl carbonate, methylpropyl carbonate, methylbutyl carbonate, methylpentyl carbonate, diethyl carbonate, ethylpropyl carbonate, ethylbutyl carbonate, dipropyl carbonate, propylene carbonate, ethylene carbonate, propylyne carbonate, or a combination thereof; or other materials like dimethylformamide (DMF).

The amount of solvent/plasticizer added to the electrochromic material composition can range from about 1 to about 50 wt. % based on the total weight of the composition, specifically about 5 to about 30 wt. %, and more specifically about 10 to about 20 wt. %.

The electrochromic material composition can be prepared as a thermoplastic, capable of forming a melt when heated. The melt can be processed by extruding or molding the melt to form a melt processed electrochromic material composition, wherein the molding can be injection molding, blow molding, rotational molding, or compression molding and the extruding can be cast film extrusion. The melt processable electrochromic material composition may comprise a salt, a plasticizer, or a combination thereof. Being melt processable allows for solvent free processing into a variety of shapes, sizes, and contours including films, structures, fiber for various applications.

Known melt processing techniques in the industry, such as known melt processing techniques for PET and PEN type polymers, can be used. Exemplary melt processing techniques include extrusion and molding. In extrusion, solid polymer is melted and then shaped in a continuous part of a defined cross section by screw-conveying and forcing the melt to flow through a die. Die forming can be used to prepare pipe and tubing, film, sheet, wire, fiber, and the like. Molding can also involve non-continuous processes such as injection molding, blow molding, rotational molding, and compression molding, in which three-dimensional parts are made in a closed mold, or by thermoforming, transfer molding, dip molding, and the like. The melt processable electrochromic polymer materials can be 3-D printed using an appropriate 3-D printing device. The melt processable electrochromic polymer materials can be processed using Roll-to-roll (R2R) techniques for the formation of films.

The electrochromic materials and compositions described herein can be solvent processable. In an embodiment, the electrochromic materials and compositions can be formed into a layer by combining the electrochromic material, salt, and a solvent to form a mixture in the form of a dispersion or solution, and applying the mixture to a substrate via conventional processes including flow coating, ink jet printing, screen printing, roll to roll printing processes, reel to reel processing, spin coating, meniscus and dip coating, spray coating, brush coating, doctor blade application, curtain casting, drop casting, and the like. The mixture can optionally further comprise a plasticizer.

Suitable solvents may include a liquid aprotic polar solvent such as propylene carbonate, ethylene carbonate, butyrolactone, acetonitrile, benzonitrile, nitromethane, nitrobenzene, sulfolane, dimethylformamide, N-methylpyrrolidone, or the like, or a combination thereof. If appropriate, polar protic solvents include, for example, water, methanol, ethanol, propanol, isopropanol, butanol, or the like, or a combination thereof. Other non-polar solvents such benzene, toluene, methylene chloride, carbon tetrachloride, hexane, diethyl ether, tetrahydrofuran, or the like, or a combination thereof may also be used.

### Electrochromic Devices

The electrochromic materials and compositions can be used to prepare an electrochromic device comprising the electrochromic material or composition thereof, an electrolyte, and two or more electrodes. The electrochromic device can be any type, e.g., absorptive/transmissive or absorptive/reflective.

The electrolyte compositions for use in the electrochromic device include those known for use in electrochromic devices. The electrolyte composition may include metal salts, organic salts (e.g., ionic liquids), inorganic salts, and the like, and a combination thereof.

In one embodiment the electrolyte composition is a gel electrolyte, specifically a crosslinked gel electrolyte. The gel electrolyte can be prepared from a gel electrolyte precursor mixture comprising a gel electrolyte precursor and a solvent. The gel electrolyte precursor can be monomeric or polymeric. In particular, the gel precursor is a crosslinkable polymer. The crosslinkable polymer can comprise polymerizable end groups, polymerizable side-chain groups, or a combination thereof attached to a polymer backbone. Exemplary polymer backbones include polyamides, polyimides, polycarbonates, polyesters, polyethers, polymethacrylates, polyacrylates, polysilanes, polysiloxanes, polyvinylacetates, polymethacrylonitriles, polyacrylonitriles, polyvinylphenols, polyvinylalcohols, polyvinylidenehalides, copolymers thereof, or a combination thereof. More specifically, the gel precursor is a cross-linkable polyether. Exemplary polyethers include poly(alkylene ethers) and poly(alkylene glycol)s comprising ethyleneoxy, propyleneoxy, and butyleneoxy repeating units. Hydroxyl end groups of poly(alkylene glycols) can be capped with polymerizable vinyl groups including (meth)acrylate and styryl vinyl groups to form a crosslinkable polyether. In particular, the crosslinkable polymer is poly (ethylene glycol) methyl ether acrylate (PEG-MA), poly(ethylene glycol) diacrylate (PEG-DA), poly(propylene glycol) diacrylate (PPG-DA), poly(butylene glycol) diacrylate (PBG-DA), poly(ethylene oxide) (PEO), poly(propylene oxide) (PPO), poly(butylene oxide) (PBO), or a combination thereof. The crosslinkable polymer can also be a copolymer or a block copolymer comprising ethyleneoxy, propylenoxy, or butyleneoxy repeating units. In one embodiment, the gel precursor is PEG-MA. In one embodiment, the gel precursor is PEO and is crosslinked thermally. In one embodiment, the gel precursor is PEO and is crosslinked using UV radiation. In one embodiment, the gel precursor is crosslinkable polymer comprising a mixture of PEG-DA and PEO, wherein the PEO:PEG-DA weight ratio is from 95:5 to 5:95, more specifically 90:10 to 10:90, and even more specifically 60:40 to 40:60 or 50:50.

The electrolyte composition can comprise an alkali metal ion of Li, Na, or K. Exemplary electrolytes, where M represents an alkali metal ion, include MClO₄, MPF₆, MBF₄, MAsF₆, MSbF₆, MCF₃SO₃, MCF₃CO₂, M₂C₂F₄(SO₃)₂, MN(CF₃SO₂)₂, MN(C₂F₅SO₂)₂, MC(CF₃SO₂)₃, MCₙF₂ₙ₊₁SO₃ (2≤n≤3), MN(RfOSO₂)₂ (wherein Rf is a fluoroalkyl group), MOH, or a combination thereof. In particular, the electrolyte composition comprises a lithium salt. More particularly, the lithium salt is lithium trifluoromethanesulfonate. Other suitable salts include tetra-n-butylammonium tetrafluoroborate (TBABF₄); tetra-n-butylammonium hexafluorophosphate (TBAPF₆); or a combination thereof. When a gel electrolyte is used, the concentration of the electrolyte salt may be about 0.01 to about 30 wt. % of the gel electrolyte precursor, specifically about 5 to about 20 wt. %, and yet more specifically about 10 to about 15 wt. % of the gel electrolyte precursor.

The gel electrolyte precursor mixture can also comprise a solvent or plasticizer to enhance the ionic conductivity of the electrolyte. These may be high boiling organic liquids such as carbonates, their blends or other materials like dimethylformamide (DMF). In particular the solvent can be a carbonate, for example alkylene and alkylyne carbonates such as dimethyl carbonate, ethylmethyl carbonate, methylpropyl carbonate, methylbutyl carbonate, methylpentyl carbonate, diethyl carbonate, ethylpropyl carbonate, ethylbutyl carbonate, dipropyl carbonate, propylene carbonate, ethylene carbonate, propylyne carbonate, or a combination thereof. The amount of solvent added to the gel electrolyte precursor mixture can range from about 1 to about 50 wt. % of the gel electrolyte precursor mixture, specifically about 10 to about 40 wt. %, and more specifically about 20 to about 30 wt. % of the gel electrolyte precursor mixture.

The gel electrolyte precursor mixture can further comprise other additives such as photochemical sensitizers, free radical initiators, and diluent polymers, providing the desired properties of the electrochromic device are not significantly adversely affected; for example, the ionic conductivity of the gel electrolyte, the switching speed of the electrochromic response, color contrast of the electrochromic response, adhesion of the gel electrolyte to the substrate, and flexibility of the electrodes.

The electrolyte composition may contain an ionic liquid. Ionic liquids are organic salts with melting points under about 100° C. Other ionic liquids have melting points of less than room temperature (˜22° C.). Examples of ionic liquids that may be used in the electrolyte composition include imidazolium, pyridinium, phosphonium or tetralkylammonium based compounds, for example, 1-ethyl-3-methylimidazolium tosylate, 1-butyl-3-methylimidazolium octyl sulfate; 1-butyl-3-methylimidazolium 2-(2-methoxyethoxy)ethyl sulfate; 1-ethyl-3-methylimidazolium bis(pentafluoroethylsulfonyl)imide; 1-ethyl-3-methylimidazolium bis(trifluoromethylsulfonyl)imide; 1-ethyl-3-methylimidazolium bromide; 1-ethyl-3-methylimidazolium hexafluorophosphate; 1-butyl-3-methylimidazolium bromide; 1-butyl-3-methylimidazolium trifluoromethane sulfonate; 1,2-dimethyl-3-propylimidazolium tris(trifluoromethylsulfonyl)methide; 1,2-dimethyl-3-propylimidazolium bis(trifluoromethylsulfonyl)imide; 3-methyl-1-propylpyridinium bis(trifluormethylsulfonyl)imide; 1-butyl-3-methylpyridinium bis(trifluormethylsulfonyl)imide; 1-butyl-4-methylpyridinium chloride; 1-butyl-4-methylpyridinium hexafluorophosphate; 1-butyl-4-methylpyridinium tetrafluoroborate; 1-n-butyl-3-methylimidazolium hexafluorophosphate (n-BMIM PF₆); 1-butyl-3-methylimidazolium tetrafluoroborate (BMIM BF₄); phosphonium dodecylbenzenesulfonate; phosphonium methanesulfonate; or a combination thereof.

The amount of ionic liquid that can be used in the gel electrolyte precursor mixture can range from about 10% to about 80 wt. %, specifically about 20% to about 70 wt. %, more specifically about 30% to about 60 wt. %, and yet more specifically about 40% to about 50 wt. % of the gel electrolyte precursor mixture.

The gel electrolyte precursor can be converted to a gel via radical crosslinking initiated by thermal methods, or in particular by exposure to ultraviolet (UV) radiation. In an exemplary embodiment, the wavelength of UV irradiation is about 365 nm although other wavelengths can be used.

The gel electrolyte precursor mixture may comprise a thermal initiator or a photoinitiator. Photoinitiators may be used to promote the photochemical crosslinking of the gel electrolyte precursors. Any suitable photoinitiator known in the art can be used, including for example, phosphine oxide photoinitiators, ketone-based photoinitiators, such as hydroxy- and alkoxyalkyl phenyl ketones, and thioalkylphenyl morpholinoalkyl ketones; and benzoin ether photoinitiators. Exemplary photoinitiators include benzophenone, 2,2-dimethoxy-2-phenylacetophenone (DMPAP), dimethoxyacetophenone, xanthone, and thioxanthone. In one embodiment the initiator may include 2,2-dimethoxy-2-phenyl-acetophenone (DMPAP). The exact range of amounts of photoinitiator may be selected by those skilled in the art.

Crosslinking may also be thermally induced at about 40° C. to about 70° C., specifically about 50° C. using a thermal initiator. Exemplary thermal initiators include peroxide initiators such as benzyl peroxide (BPO), or azo bis isobutylnitrile (AIBN).

In one embodiment, the gel electrolyte precursor mixture comprises the electrolyte salt (e.g. metal salts, organic salts (e.g., ionic liquids), inorganic salts, or a combination thereof) and the gel precursor in a weight ratio of 1 to 10, with a 0.002 to 1 to 10 ratio of initiator to electrolyte to gel precursor, by weight.

Exemplary gel polymer electrolytes include those described in U.S. Pat. Nos. 7,586,663 and 7,626,748, both to Radmard et al., both incorporated herein by reference in their entirety.

The electrochromic devices may optionally further include a variety of substrate materials (flexible or rigid) used to house the electrolyte/electrochromic material composition combination. Exemplary substrate materials include glass, plastic, silicon, a mineral, a semiconducting material, a ceramic, a metal, and the like, as well as a combination thereof. The substrate may be inherently conductive. Flexible substrate layers can be made from plastic. Exemplary plastics include polyethylene terephthalate (PET), poly(arylene ether), polyamide, polyether amide, etc. It is to be understood that these plastic substrates do not function as an electrochromophore as they do not contain a salt and/or plasticizer within the PET/PEN layer yielding no/lower ionic conductivity.

The substrate may include mirrored or reflective substrate material.

Exemplary electrode materials for use in the electrochromic devices can include inorganic materials such as glass-indium doped tin oxide (glass-ITO), doped silicon, metals such as silver, gold, platinum, aluminum, and the like, metal alloys such as stainless steel (“SS”), SS 316, SS316L, nickel and/or cobalt alloys such as Hastelloy-B® (Ni62/Mo28/Fe5/Cr/Mn/Si), Hastelloy-C®, and the like; and organic materials such as a conjugated polymer such as poly(3,4-ethylenedioxythiophene)-polystyrene sulfonate (PEDOT-PSS), conjugated polymers, carbon black, carbon nanotubes, graphene, and the like.

In one embodiment, all of the electrodes are polyethylene terephthalate (PET)/indium-doped tin oxide (ITO) substrates.

The electrochromic device can generally be fabricated by encasing a layer of the combination of electrolyte composition and a layer of electrochromic material composition between at least two electrodes, wherein the electrodes are in electrical communication with the layers of electrolyte composition and electrochromic material composition.

The electrochromic material composition can be formed into a layer by mixing the electrochromic material and salt components with an appropriate solvent to form a mixture in the form of a dispersion or solution, and applying the mixture to a substrate by solvent processes including ink jet printing, screen printing, roll to roll printing processes, reel to reel processing, spin coating, meniscus and dip coating, spray coating, brush coating, flow coating, doctor blade application, solution casting, curtain casting, drop casting, film casting, and the like.

In an embodiment, the electrochromic material composition layer can be prepared by heating the electrochromic material and salt components to form a melt in the absence of a solvent, and formed by extrusion, e.g. cast film extrusion, or molding. The ability to melt process the polymer and copolymer electrochromic materials described herein has clear advantages over alternative methods of forming electrochromic devices. For example, vacuum depositing metal oxide onto a substrate to generate an electrochromic for electrochromic window technology is expensive. Processes using solution casting of electrochromic polymer films onto a substrate can involve large quantities of solvent requiring expensive disposal requirements. Furthermore, solution casting can only prepare films. Melt processing does not require a substrate and leads to very different morphologies compared to solution casting. The melt processed polymer can be a film or both the film and the substrate. Melt processing offers not only films as a product but electrochromic materials that can be shaped in many different ways. For example, the melt processable electrochromic material can be blow molded into bottles or containers. Further, the melt processable electrochromic material can be melt spun into fibers. In addition to the various shapes that the melt processable polymers can take, melt processability also offers a pathway to recyclability.

Melt processing of electrochromic materials allows for the preparation of a film that can be produced and sold as a roll. An optically transparent conductor can be coated on this roll to form the electrochromic device. In an alternate embodiment, the melt processed film can be pressure encapsulated by laminating ITO coated substrate (e.g. PET) on each side of the melt processable electrochromic material. Other melt processing techniques may be used to form the electrochromic material into any number of shapes, as described herein. Melt processing can be conducted on a very large scale and leads to high throughput, cost-effective processes that are less toxic due to the avoidance of solvent use in the process.

The electrochromic materials and devices described herein find use in personal, household, transportation, and building sectors. Automotive applications include rear view mirrors, sunroofs, wind-shields, windows and the like; eyewear applications including eyeglasses, goggles, sunglasses, visors, and the like; architectural windows; smart glass; windows; displays (e.g., billboards and signs, video monitors, flat panel displays, flexible displays, and the like); sensors; OLEDs; solar cells; electrochromic (color change) fabrics and textiles; adaptive camouflage; electrochromic plastic wrap for food, household goods, packaging, and the like; and containers and packaging, including bottles, and the like. Electrochromic devices that exhibit neutral color transitions are of special interest in the eyewear industry.

In a further embodiment, an electrochromic device comprises an electrochromic layer comprising an electrochromic material composition, and an electrolyte layer, wherein the electrochromic layer is adjacent to the electrolyte layer.

### Polycannabinoid Dielectrics, Bioplastic for Capacitive Energy Storage

Polycannabinoids have been found to be useful as bioplastics for capacitive energy storage and can be prepared into capacitor materials. As dielectric materials, the cannabinoid unit of the polymer can crosslink, be pendant, etc. The polycannabinoids can be used in power electronics (aliphatic, allyl cyclics, etc.). Furthermore, high temperature polycannabinoids can be prepared.

Polycannabinoids such as poly(cannabidiol terephthalate) (PCBDT) have been found to exhibit capacitive energy storage properties and are easily degraded.

In an embodiment, the polycannabinoid is prepared as a film and used in dielectric film capacitors based on the capacitive energy storage properties of the polymer.

As polymer-based dielectric film capacitors find extensive applications in high-energy storage sectors such as automotive and aerospace, there is a huge potential for sustainable polymer dielectrics. The versatile nature of polycannabinoids provides a platform to develop naturally degradable polymers for combating environmental pollution.

Over the last decade, there has been a huge demand for polymer dielectrics for capacitive energy storage as they offer a comparatively higher breakdown strength, flexibility, ease of processing, variable structural design, and a smoother failure mode than conventional dielectric materials. Polymers such as polylactic acid (PLA), polybutylene adipate terephthalate (PBAT), polyhydroxyalkanoates (PHAs), cellulose, etc. are popular biobased and/or biodegradable polymers but they are not usually designed for electrical or electronic applications. Many of these biobased and naturally degradable polymers are not desired for applications requiring high thermal stability and harsh electrification conditions (high-performance polymers). Polyimides (PI), polyetherimide (PEI), polyamides (PA), polyether ketone (PEEK), biaxially oriented polypropylene (BOPP), polyphenyl sulfide (PPS), polyethylene terephthalate (PET), and polyethylene naphthalate (PEN) which are usually employed for high-temperature capacitive energy storage have a high petroleum content and are not easily degradable. The development of high-performance bioplastics, especially those that outperform existing petroleum-based options, creates new opportunities to develop market viability for bioplastics and drive down their prices.

Cannabidiol (CBD) is one of the most abundant cannabinoids in the hemp plant. Its rigid aromatic center, together with two phenolic functional groups make it a promising contender for step-growth polymerization reactions. The presence of double bonds on the non-aromatic part of CBD can be utilized for radical polymerizations and cross-linking reactions. The well-studied antioxidative nature of CBD further enables composing polymers with antioxidant properties. All these factors emphasize the potential of polycannabinoids in generating bio-based materials that can be chemically modified and tuned for use in several EEE and high-performance applications.

PCBDT outperforms PET as a high-temperature dielectric. Unlike that of most bio-based polymers, the biomass feedstock for this polyester is not a food crop, thereby mitigating concerns surrounding food resource prioritization. Furthermore, this bioplastic is easily processable and was synthesized using a rapid, energy-efficient, phase-transfer polymerization procedure facilitated by biodegradable quaternary ammonium catalysts. PCBDT's dielectric capabilities are highlighted by its concurrent high glass transition temperature (Tg) and large band gap, which deviate from the inverse relationship observed in other dielectric polymers. An inverse relationship between Tg and bandgap has been observed in commonly used high-temperature polymers, as the high Tg is usually realized by aromatic groups which are prone to π-πstacking, leading to electronic coupling. Breaking the inverse relation between bandgap and Tg is therefore one key to designing a high-temperature capacitive polymer.

Furthermore, PCBDT demonstrates an augmented intrinsic hydrophobic nature which naturally hinders moisture absorption, thus reducing or eliminating the need for surface modifications and additives commonly used to enhance the hydrophobicity of conventional dielectric polymer films.

In an embodiment, a polycannabinoid dielectric capacitor comprises a polycannabinoid film positioned between two electrodes. Further within this embodiment, the dielectric capacitor is a dielectric film capacitor.

### Polycannabinoid Coatings and Paints

Disclosed herein are polycannabinoid coatings and paints. Paints and coatings can be prepared for the protection of underlying materials from the effects of oxidation. For example, this may be accomplished by incorporation of the compositions into coatings and other materials.

The polycannabinoid paints and coatings can provide anti-oxidant protection and can provide color fastness (fabrics). The paints and coatings can be prepared as clear, colorless, colored, transparent, etc. for any particular need. The polycannabinoid paints and coatings can also provide hydrophobicity.

Uses of such paints and coatings include for art preservation, e.g., for protection of metal sculpture; superconductor protection; anti-oxidant protection; color fastness (fabrics).

In an exemplary embodiment, the polycannabinoid paints and coatings can be applied to metal surfaces to form metal nanocomposites from the oxides (metal oxide turns to metal reduced by the antioxidant cannabinoid polymer), for example used for reversing “rust”. Various metal surfaces include iron, steel, copper, silver, and the like.

In an embodiment, the polycannabinoid is applied to a surface in the form of a solution or suspension of polycannabinoid and a solvent or liquid carrier. After application, the solvent or liquid carrier is removed, e.g. by evaporation leaving behind a film or coating of polycannabinoid. Suitable solvents or liquid carriers include water, organic solvents such as an alkyl alcohol (e.g., methanol, ethanol, propanol, isopropanol, butanol, etc.), chlorinated solvents (e.g. methylene chloride, chloroform, carbon tetrachloride), alkyl ketones (e.g. acetone, methyl ethyl ketone, etc.), hydrocarbons (benzene, toluene, hexane, etc.), alkyl ethers (diethyl ether, tetrahydrofuran, 1,4-dioxane, etc.), aqueous mixtures of water and organic solvent, or a combination thereof.

In an embodiment, a polycannabinoid paint can be prepared from particle emulsions in water which have use for its application into coatings. Petroleum based monomers such as styrene, butadiene, methyl methacrylate, methacrylic acid, butyl acrylate, hydroxy ethyl acrylate, hydroxy ethyl meth acrylate, etc. are commonly used monomers for emulsion polymerization to form latex particles. This latex emulsion is widely used for paint, coating, adhesive and sealants application currently across the industries. Use of cannabidiol based latex particle brings the important characteristic properties of high hydrophobicity, non-phenolic antioxidant, and environmental sustainability as it is bioderived material.

Cannabidiols are biobased, biodegradable, and non-phenolic antioxidant materials that can be used for paint and coating applications. It has been found that CBD and CBG are cannabidiols which copolymerized well with the terpene molecule myrcene as well as petroleum-based monomers such as styrene, methyl methacrylate (MMA), and butadiene via emulsion polymerization to make nano size latex particles for high performance coating applications. The latex particle size was measured by dynamic light scattering instruments which came around 40-50 nm range. The pH of the emulsion was around 8-9. The solid content of emulsion was around 30-40%.

The synthesized latex polymer can directly be used for coating applications without any further purification. It can also be used as a main formulation component of waterborne paint along with pigments, extenders, rheology modifiers, other additives, or a combination thereof. When a thin layer of the emulsion is coated on a substrate surface, the latex particles would coalesce to each other, and water evaporates by capillary forces to form hard and solid polymer coating film on the substrate. Polycannabinoid paints and coatings can be used to provide aesthetic attributes and protection to the different surfaces.

The latexes made from cannabidiols and myrcene are bioderived and biodegradable compared to the traditional petroleum derived ones. Therefor it is more environmentally sustainable and has less carbon footprints. Cannabidiols also provide the unique property of being non-phenolic antioxidants which prevent the oxidation or aging of any surface coated with it. This property is hard to find in petroleum-based monomers. Polymer coating from polycannabidiol based emulsion would be highly hydrophobic in nature which could provide unique barrier properties from oxygen and water. Emulsions made from cannabidiol have been found to be stable for at least three months at room temperature and form uniform thickness clear film on glass and metal surfaces.

In an embodiment, the polycannabinoid latex particles can be copolymerized with another unsaturated monomer in an emulsion based polymerization, such monomers include, for example, a terpene such as myrcene, 1,3-butadiene, styrene, vinyl acetate, an acrylate, a methacrylate, and the like according to the following structure, or a combination thereof

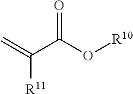

R¹¹=H or CH₃; R¹⁰=C₁-C₁₀ alkyl, e.g. methyl, ethyl, n-butyl, hydroxyethyl, etc.

The following examples are merely illustrative of the polycannabinoid based compositions and uses disclosed herein and are not intended to limit the scope thereof.

### Examples

### Example 1. Polycannabinoid Electrochromic—Poly(Cannabidiol Terephthalate

(pCBDT) pCBDT Synthesis: 3.93 grams (g) of cannabidiol and 1 g of sodium hydroxide was dissolved in 80 milligrams (mg) of deionized (DI) water. After stirring 25 mg of tetrabutylammonium bromide was added and the solution changed to a dark purple color. 2.53 g of terephthoyl chloride was dissolved in 30 milliliters (ml) of dichloromethane and was added to the aqueous solution. The reaction was run for 10 minutes and then quenched with acetone. The precipitated polymer was purified using 10% hydrochloric acid and reprecipitated in cool methanol. The polymer product was characterized through NMR, GPC, DSC, TGA analysis. The chemical structure of pCBDT is as follows:

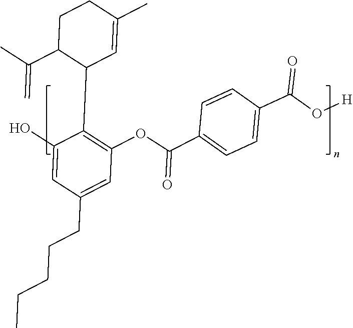

Electrochromic Device Fabrication: A solution was prepared using 50 mg pCBDT, 30 mg TBAPF₆ dissolved in 2 g of chloroform. The solution was coated onto ITO glass using a spin coater at 750 rpm for 30 seconds and oven dried at 111° C. for 10 minutes.

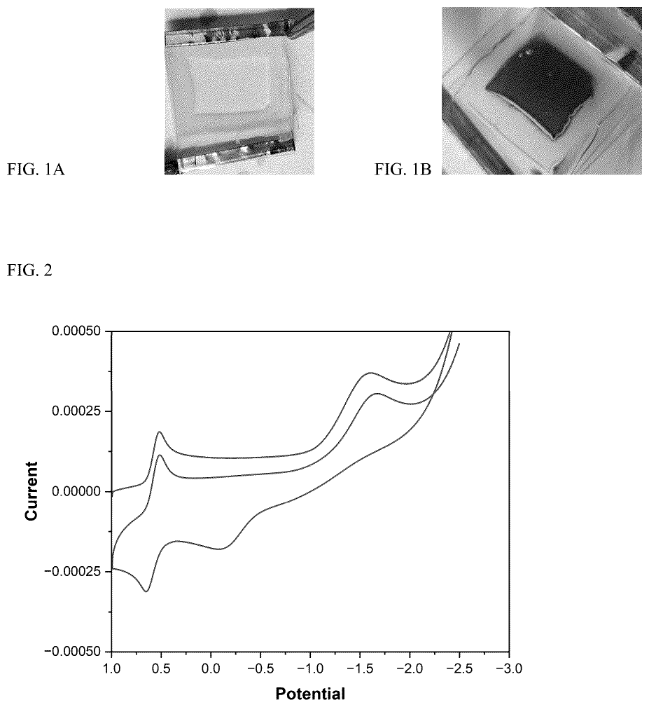

The electrochromic device was assembled with a rubber gasket mold with ˜1 ml of electrolyte solution (0.72 g propylene carbonate, 0.528 PEG-MEA, 0.162 PEG-DMA, 0.136 TBAPF₆ and 2-3 mg of BAPO) and crosslinked in the UV-Crosslinker for 15 minutes at 365 nm before testing. FIG. 1A-1B are images of the pCBDT electrochromic device in bleached state (FIG. 1A) and reduced state (FIG. 1B, where the polymer exhibits an indigo color).

FIG. 2 illustrates cyclic voltammetry of pCBDT in 0.1M TBAPF₆ Acetonitrile with a Ag/Ag+ reference electrode. Ferrocene is included as an internal reference.

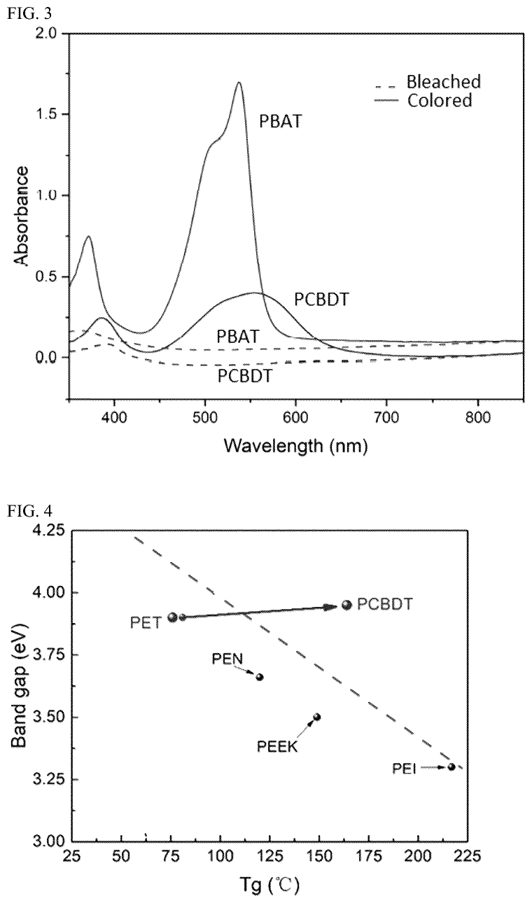

FIG. 3 illustrates the absorbance spectra of pCBDT electrochromic device switched from 0 V (bleached; dashed line) to −4.4 V (colored; solid line). Table 1 reports the photopic transmission and color space for neutral and reduced pCBDT.

TABLE 1

| | Photopic | | | |
|---|---|---|---|---|
| Sample | transmission | L* | A* | B* |
| Neutral pCBDT | 74.4 | 89.1 | 3.4 | −0.8 |
| Reduced pCBDT | 15.4 | 46.2 | 56.2 | −37 |

A poly(butylene adipate-co-terephthalate) (PBAT) electrochromic device was also prepared and tested. The chemical structure of PBAT is

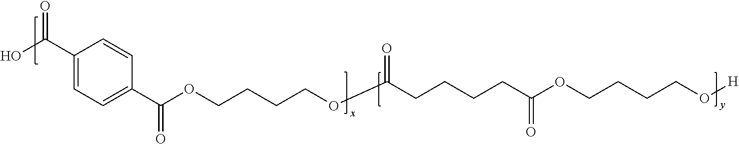

Device assembly: Ecoflex F Blend C₁₂₀₀, PBAT was purchased from BASF corporation. PBAT was dissolved in chloroform (5% by wt) and deposited onto ITO coated substrate using a spin coater at 750 rpm for 30 seconds. The device was cooled in the oven 111° C. for 15 minutes prior to assembly. The electrochromic device was assembled with a rubber gasket mold with ˜1 ml of electrolyte solution (0.72 g propylene carbonate, 0.528 PEG-MEA, 0.162 PEG-DMA, 0.136 TBAPF₆ and 2-3 mg of BAPO) and crosslinked in the UV-Crosslinker for 15 minutes at 365 nm before testing.

PBAT electrochromic device was clear in (0 V) neutral state and provided a magenta color in the (−4.4 V) reduced state. FIG. 3 reports the absorbance spectra of PBAT electrochromic device switched from 0 V (bleached state; dashed line) to −4.4 V (colored state; solid line).

Additional electrochromic devices can prepared with the polycannabinoid polymers described herein, including poly(cannabidiol naphthalate):

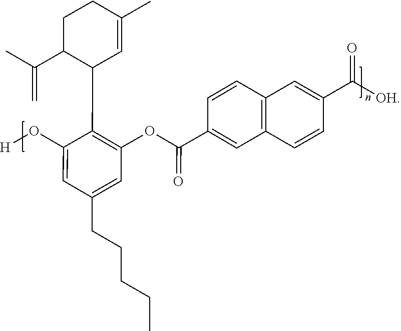

### Example 2. Sustainable Bioplastic for Capacitive Energy Storage—Rapid Synthesis of Poly(CBD Terephthalate

Materials—Cannabidiol (CBD) was purchased from EcoGen BioSciences, terephthaloyl chloride, dichloromethane (DCM), cetrimonium bromide (CTAB), and Benzyltriethylammonium chloride (BTEAC) were purchased from Fisher Scientific. Sodium hydroxide (NaOH), and tetrabutylammonium bromide (TBAB) were purchased from Sigma Aldrich. All chemicals were used without further purification. ^{l}H NMR was collected using a Bruker AVANCE 500 MHz instrument. Thermo Gravimetric Analysis was conducted using a TA Instruments TGA Q-500, and DSC was collected using a TA Instruments DSC Q-20. GPC was taken using a WATERS GPC equipped with a 1515 HPLC Pump and Waters 717Plus Autoinjector. UV measurements were done using an Agilent 5000 Varian Cary 5000 UV/VIS/NIR Spectrometer.

Synthesis via a phase transfer catalyzed polymerization technique.

Aqueous phase composition: The reaction was carried out in a 250 ml round bottom flask to which 80 ml of distilled water and 0.025 moles of NaOH were added. To this, 0.0125 moles of CBD were added and stirred vigorously until the solution turned dark purple. Further, 25 mg of phase transfer catalyst (CTAB) was added.

Organic phase composition: In a 100 ml Erlenmeyer flask, 0.0125 moles of terephthaloyl chloride were well dissolved in 35 ml of dichloromethane.

Polymerization: The organic phase was dropped into the stirring aqueous phase, and the reaction was underway. After 10 minutes, the stirring was stopped, and the polymer formed in the organic phase. The organic phase was then separated using a separation funnel and the polymer was precipitated in excess of cold methanol. The polymer was washed once with water and then once with acetone to remove the unreacted compounds. The polymer was dried overnight in a closed vacuum at 70° C. to remove the solvent and water.

Polymer P3—(5.96 g, 92% yield). Mn 25,102 g/mol, Mw 57,735 g/mol, PDI 2.3. ¹H NMR (500 MHz, CDCl₃): δ (ppm): 8.36 (s, 4H), 6.98 (s, 2H), 5.35 (s, 1H), 4.67 (s, 1H), 4.53 (s, 1H), 3.67 (d, 1H), 2.70 (m, 2H), 1.56-1.80 (m, 10H), 1.39 (m, 4H), 1.29 (s, 3H), 0.94 (t, 3H).

The efficiencies of a few commercially available quaternary ammonium salts in the phase transfer catalyzed polymerization to form polycannabinoids were tested (Table 2).

TABLE 2
Variation of molecular weight (Mn) with
changing phase-transfer catalysts.

| | | Polymer | | |
|---|---|---|---|---|
| Polymer | Phase-Transfer Catalyst | Yield (%) | Mn | PDI |
| P1 | Tetrabutylammoniam bromide | 95 | 47,000 | 1.87 |
| | (TBAB) | | | |
| P2 | Benzyltriethylammonium chloride | 88 | 23,000 | 2.1 |
| | (BTEAC) | | | |
| P3 | Cetrimonium bromide (CTAB) | 92 | 25,100 | 2.3 |

CBD was polymerized with terephthaloyl chloride via a phase transfer catalyzed polymerization technique. In a NaOH aqueous phase, CBD forms a dianion with sodium and is well solubilized in the alkaline environment within minutes. Furthermore, in the presence of a quaternary ammonium salt, this dianion is readily coordinated to form an ionic complex that is easily transferred to an organic phase. The organic phase in this reaction contains terephthaloyl chloride in dichloromethane and is where the polymerization reaction occurs. After transfer to the organic phase, the phase transfer catalyst drives the reaction equilibrium forward by coordinating with the chloride leaving group and drawing it to the aqueous phase, where the chloride ion is dissolved, and the quaternary ammonium cation can coordinate with another CBD dianion to start the phase transfer catalysis again. The ability of the phase transfer catalyst to facilitate the transfer of anions back and forth across the interface allows for a high polymerization yield and molecular weight. Quaternary ammonium salts make favorable phase transfer catalysts due to their low toxicity, low cost, biodegradability, and the ability to wash most of them away from the reaction product by extraction with water. The efficiencies of a few commercially available quaternary ammonium salts were tested (Table 2), and polymerization using tetrabutylammonium bromide produced the highest molecular weight.

The reaction is energy-efficient and rapid, reaching completion in less than 10 minutes at ambient temperature and pressure, largely due to the enhanced nucleophilicity of CBD as a dianion and the aid of vigorous stirring to maximize the interfacial surface area. Thus, this phase transfer catalyzed polymerization offers technical benefits over traditional synthetic approaches like solution polymerization which may require several days to reach completion and melt polymerization which often requires the use of rare or toxic metal catalysts. The high biomass content in the polymer is evident as CBD contributes to about 67% by mass of the final polymer. Free-standing films of PCBDT displayed excellent transparency and were further used for dielectric characterizations.

The successful synthesis of the PCBDT was confirmed using ¹H NMR. The NMR spectrum for CBD shows two phenolic hydrogen peaks, one at 6.00 ppm and the other overlapping with peaks between 4.5-5.00 ppm. Upon polymerization, the two phenolic peaks disappear, while the aromatic hydrogens of CBD shift downfield as the phenol functionalities around them change to more electron-withdrawing ester functionalities. The differential scanning calorimetry (DSC) results show that PCBDT exhibits a Tg of 164° C., while thermal gravimetric analysis (TGA) yields a thermal decomposition temperature of approximately 377° C. PCBDT shows a higher Tg than several commercial polyesters and bisphenol A-based polycarbonates, which is mainly attributed to the rigid aromatic structure of both monomers together with the bulky side groups on CBD. The alicyclic limonene unit of CBD that is separated from its aromatic group can further enhance the rigidity without increasing the conjugation of the structure. Therefore, compared to PET, the Tg is elevated from 70° C. to 164° C. without reducing the bandgap (3.9 eV), making the PCBDT an outlier relative to the inverse Bandgap vs. glass transition (Tg) relationship of established commercial technical polymers, as shown in FIG. 4.

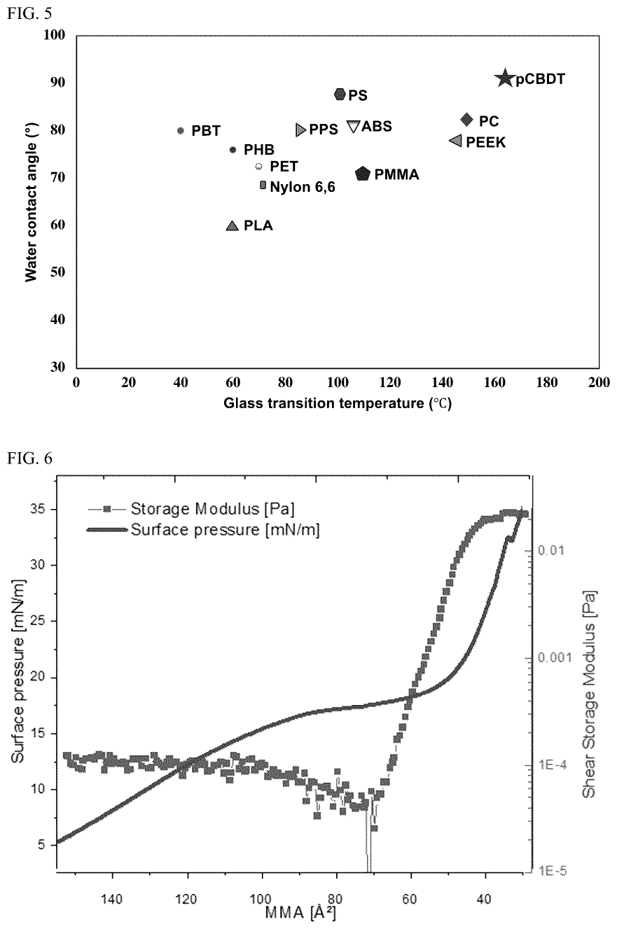

A sessile drop method was used to measure the water contact angle of a PCBDT film. The average of four sets of results shows a water contact angle of 91° making it a hydrophobic polymer film. As shown in FIG. 5, the contact angle of PCBDT is substantially higher than that of several commercial polymers. FIG. 5 illustrates variation of water contact angle to the glass transition temperature of different commercially available thermoplastic polymers and PCBDT. The inherent hydrophobicity of PCBDT is a result of the excess aliphatic character of the CBD monomer which increases the hydrophobic nature of the polymer formed. The bulky side chains of CBD are unlike any of those found in commercial monomers, giving it a unique character. Due to a higher water contact angle, PCBDT films are more repellent to moisture than PET (water contact angle of 72.5° C.), polystyrene (water contact angle of 82° C.), and several other commercial dielectric polymers (FIG. 5) which is important as the dielectric constant for water is relatively high, and traces of moisture can drastically impair the dielectric performance of the polymer films. Thus, a higher hydrophobicity is advantageous in the long-term application of polymer dielectrics.

Preparation of polymer films: 10 wt. % of PCBDT in tetrahydrofuran (THF) solution was prepared and kept on stirring for at least 4 hours. Films were cast on a glass substrate having a smooth surface, by using a motorized drawdown coater. The doctor blade was set to an initial casting thickness of 380 μm. After drying the casted film for 4 hours at 25° C. it was removed from the glass plate using DI water to give a free-standing film. The obtained free-standing film was further dried under vacuum at 70° C. for 24 hours. The dried films were flexible and had a thickness of around 10-12 microns.

High Field Displacement-Electric Field Loop Measurement: The electric displacement-electric field (D-E) loops were assessed using a customized Sawyer-Tower polarization loop tester, which utilized a unipolar positive half sinusoidal wave at 100 Hz. The measurement apparatus was a Trek Model 10/40 10 kV high voltage amplifier in conjunction with an OPA541 operational amplifier-based current-to-voltage converter. To ensure proper contact between the electrodes and the film, gold/palladium electrodes measuring 3 mm in diameter were deposited on both sides of the film using the sputter coating technique.

Dielectric Spectroscopy: Dielectric spectroscopy measurements were conducted using a Solartron SI 1260 frequency response analyzer paired with a Solartron 1296 dielectric interface. The tested sample was housed within a test cell and exposed to controlled temperature conditions regulated by a Delta Design 9015 temperature controller. This controller ensured exceptional temperature stability, keeping fluctuations within a narrow range of ±0.5° C. throughout the entire measurement procedure. Gold/palladium electrodes, with a diameter of 30 mm, were applied to the sample to facilitate intimate contact between the electrode and the dielectric during the measurement.

Breakdown Tests: The breakdown strength of the films was tested using the high-voltage power supply PS365 with a voltage ramping rate of 500 V s−1.

Surface pressure vs. Mean Molecular Area (π-MMA) isotherms, rheology, and microscopy setup for Langmuir degradation experiments: Langmuir isotherms (2D films or monomolecular films) were recorded on a polytetrafluoroethylene medium-size Langmuir trough (Area=243 cm² KSV NIMA, Finland), filled with 170 ml water and equipped with a pair of Delrin barriers for controlling the mean area occupied per repeating unit (MMA) and a custom-made subphase evaporation compensation tool. Alternatively, a high compression trough with about twice the area and subphase volume was used. The changes in the surface tension (surface pressure a) of the air-liquid interface upon forming and compressing the monolayer were monitored by a Wilhelmy plate microbalance and recorded as a function of the MMA (lower MMA means more compressed film). Rheology experiments at the Air-Water interface were carried out with an interfacial shear rheometer (IRS, model MCR502) from Anton Paar (Austria), which consists of a biconical disk coupled to a driving motor and a torque and normal force transducer unit. The edge of the bicone is placed in the interface in the middle of the trough. The bicone had a radius of r=25.5 mm. The angle of its tip was 166.8°. Measurements were carried out at a defined strain of 0.1% and an oscillation frequency of ω=1 Hz. The dynamic moduli were recorded as a function of time and polymer surface pressure. The storage modulus (G′) accounts for the elastic component and the loss modulus (G″) for the viscous component of the response to oscillatory shear.

Microscopic images of the layer at the water surface with a maximum image size of 720×400 μm2 were obtained using a Brewster Angle Microscopy (BAM). The device was a Nanofilm Ultrabam (Accurion, Göttingen, Germany). A 658 nm class IIb laser source with a lens and a CCD camera (1360×1024 pixels) were used to take all micrographs, with a resulting the lateral resolution of ˜2 μm.

Thin-film Characterization: PCBDT solutions were prepared in chloroform at a concentration of ca. 0.25 mg/ml. For each experiment, around 60 μL of CHCl₃ solution (15 μg polymer) was spread dropwise on top of the water (air-water interface). The chloroform was allowed to evaporate for 30 min while the polymer monolayer was formed at the interface. Then, the layer is laterally compressed with the barriers at constant a compression rate of 5 mm/min. The mean molecular areas per repeating unit (MMA) for the films were calculated based on the mass of the film (15 μg), on the average weight of a repeating unit (determined by summing up the weight of the co-monomers multiplied by their molar fraction=444 g/mol for CBD-terephthalate) and the surface area of the trough during compression. All isotherms were recorded at 21° C.±0.5. The data are reproducible with a random measurement error of ≈5% concerning the surface pressure or the MMA values of the compression curve for the independently repeated experiments.

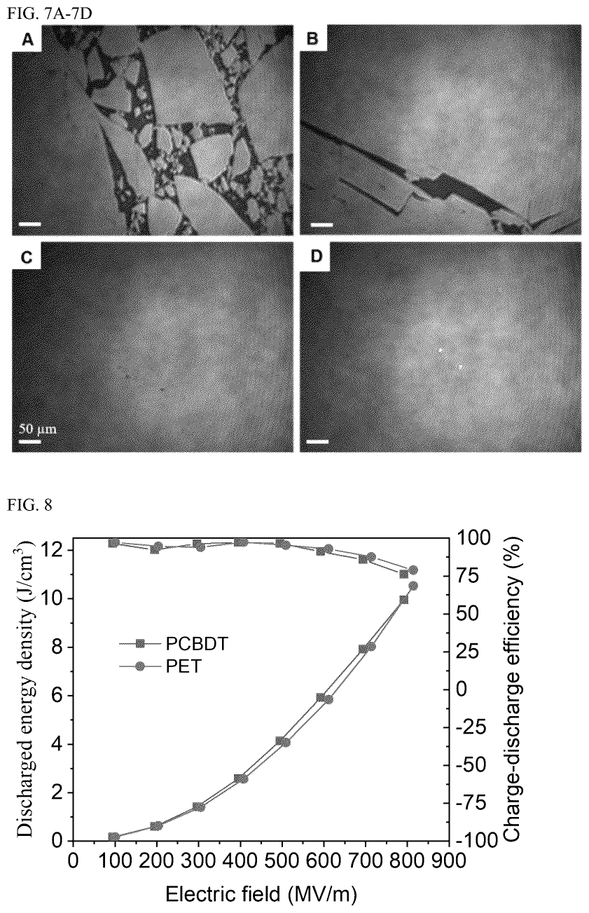

PCBDT films were formed by spreading the polymer from a chloroform solution at the surface of water (air-water interface) at pH ˜6 and 21° C., and the molecular arrangement of the polymer chains was measured upon lateral compression (FIG. 6). As evidenced in the compression isotherm (constant temperature), and in the Brewster angle microscopy images taken at different points of the isotherm, PCBDT forms slabs right after spreading (FIG. 7A). This implies that the intermolecular forces are of a similar magnitude as the spreading force generated by the high surface energy of water, which intercedes the even distribution of molecules and generates the slabs. Similar behavior has been observed with PET, however here the closed film is observed at an area per molecule that is 6 times greater than in the case of PET. The high MMA suggests that the slabs are of monomolecular thickness, which is corroborated by AFM images of the transferred film. After stabilization, the polymer layer is compressed at a constant speed, increasing the contact points between the slabs, and thus the surface pressure of the system. The slabs encounter each other and merge forming a homogenous monolayer upon compression (FIG. 7B, 7D). The isotherm shows a distinct kink at a surface pressure (SP) of about 13-15 mN/m which suggests a phase transition. The transition is also observed as an increase in the shear storage modulus (G′), i.e., the elastic part of the shear response, which was recorded by an interfacial rheometer at an area per repeating unit of 70 Å. Considering that the polymer repeating unit has a length of about 12 Å, the average. distance between the chains is about 6 Å at that point, which is quite a bit larger than the van der Waals radius of 3.5 Å as the typical interchain spacing of polymers. That the distance is larger for PCBDT is expected given the bulky side groups. This means that the solidification of the film occurs in the monolayer state when the side groups start to interdigitate. Usually, chains need to overlap and form entanglements for a polymer Langmuir film to display shear resistance. Not wishing to be bound by theory, this unique behavior is attributed to the outstanding molecular stiffness and high bulk Tg of PCBDT. In comparison, due to its lower bulk Tg, PET solidifies at room temperature at a thickness of ˜2 nm, corresponding to about 6 layers.

Degradation experiments were carried out using a medium and high-compression trough setup as explained above. The films at the A-W interface were formed and compressed to the degradation surface pressure, which should be close to the point in the compression isotherm with the greatest slope. “Long-term” hydrolytic degradation experiments were performed on a water subphase at pH 6. The degradation surface pressure for PCBDT was 14 mN/m. When polymer degradation products leave the surface and are solubilized in the subphase, the surface pressure decreases, and the barriers compress the film to compensate for the loss. The initial film area vs. final area is used to calculate the mass loss (A/A₀)%. For accelerated degradation with potassium hydroxide (KOH) pH 12 or hydrogen peroxide (H₂O₂) 3% (oxidative degradation according to ISO standard 10993-13), the films were prepared on the water, and after a few hours of stabilization, KOH (pH 14) or H₂O₂ (35 wt %) solutions were injected under the films to adjust concentration/pH.

Hydrolysis of PCBDT: End of Life (EoL) behavior is an important property for the next generation of synthetic and biobased polymers. While all polyesters can in principle be depolymerized through hydrolysis, the required conditions can be so harsh that they have to be considered as environmentally stable, as is the case for PET. Due to its hydrolysis resistance, PET is also not yet depolymerized on a commercial scale, despite its immense economic importance.

Langmuir monolayer degradation (LMD) experiments, previously used to unravel depolymerization mechanisms of (bio) catalysts on PET, were used to study the molecular degradation kinetics of PCBDT in the presence of different catalysts (OH—, H₂O₂), and benchmarked the degradability of PCBDT against PET. The first step for LMD is to characterize the assembly or deposition of the polymer of interest on a liquid surface into 2D thin films, to replicate the surface layer of a bulk material. Then, the films are subjected to hydrolysis by mixing the catalyst with the liquid below the films. This hydrolysis is monitored in situ by changes in the area occupied by polymer molecules (mass loss) and modification of the rheological properties of the films using interfacial rheology.

Langmuir Degradation Experiments: PCBDT films were prepared at an SP of 14 mN/m and monitored by surface area changes and interfacial rheology. At 14 mN/m, the storage modulus is above the loss modulus, indicating a solid-like layer. After around 20 hours, no significant changes were observed either in the storage modulus or the area of the film and the film was tested for alkaline degradation. After injection of KOH to obtain a pH of 12.3, the area of the film decreased to a mass loss of 60% in a two-stage process. First, the polymer surface pressure increased, a phenomenon that is commonly observed when increasing the pH below the films of polymers that are prone to alkaline hydrolysis as these molecules swell once the pH is above the degradation threshold. The storage modulus decreased due to the breakage of the polymer chains into shorter chains, which, however, were not yet small enough to be solubilized in the subphase (from time 10 min to 30 min). 15 minutes after KOH injection, the complex interfacial viscosity was on the same level as bare water, indicating that the molecular mass of the polymer was so low that it could not impart any shear resistance. This stage was followed by a fast decrease in the area when the barriers compensated for the desorption of degradation fragments from the surface. The maximum area reduction allowed by the experimental setup correlated to 60% mass loss, due to the space occupied by the rheometer's bicone. Based on the almost linear mass loss curve, it is justified to extrapolate that the layer will be completely dissolved within 1 hour at pH=12.3. For comparison, alkaline degradation of PET is typically carried out at pH 14 and 100° C., where complete degradation takes several hours.

Comparison of PCBDT and PET susceptibility to oxidative degradation: To simulate the -long-term stability of PCBDT for applications involving high temperature and air contact, its stability against oxidation was tested. After the films were formed as mentioned before, 35 wt % H₂O₂ was injected to reach a final concentration of 3 wt %. Almost instantly, the interfacial viscosity started decreasing, indicating chain cuts. The surface pressure increased similarly as in the case of KOH addition, which is attributed to a greater swelling of the polymer due to the hydrophilic groups formed by oxidation. After 20 hours, water-soluble fragments started forming and solubilizing in the aqueous phase, leading to a decrease in the area by 60% (maximum area loss allowed by the experimental setup). Interestingly, the decrease in interfacial viscosity was greatly accelerated by an increase in temperature (factor 10), while the rate of mass loss was only about doubled. A pronounced lag time was observed between the loss of interfacial viscosity and the onset of mass loss. Not wishing to be bound by theory, this result may relate to the hydrophobic nature of CBD, which is barely water-soluble, requiring pronounced chain fragmentation to the monomer level and potentially further oxidation of the CBD monomers to enable solubilization. The processes of chain fragmentation and solubilization appear to have different temperature dependencies.

The oxidative degradability of PCBDT was benchmarked against PET. There is a marked difference in degradation behavior. The mass loss of PET sets in almost immediately upon exposure to hydrogen peroxide, but proceeds slowly and with constant (40° C.) or even increasing (20° C.) interfacial viscosity while no swelling is observed. Not wishing to be bound by theory, it is inferred that this gradual mass loss is due to a surface erosion process of the 2-3 nm thick film, in contrast to PCBDT which forms a true monolayer (0.3 nm thickness). This monolayer is much more susceptible to losing its shear modulus through chain cuts when compared to the thicker PET layer. The monomers and smaller fragments of PET are readily water-soluble, so the lag time for PET dissolution under oxidative conditions is very short compared to PCBDT. Altogether, PCBDT is more susceptible to hydrolytic degradation than PET, which is beneficial for environmental biodegradability or industrial depolymerization but shows slower mass loss under oxidative conditions.

Dielectric Properties and Capacitive Performance: The dielectric constant and dissipation factor for PCBDT and commercial PET as a function of temperature and frequency were studied. PCBDT demonstrates remarkable thermal stability of its dielectric constants, spanning the temperature range from 30° C. to 150° C., with a temperature coefficient of the dielectric constant of around −0.056% ° C.⁻¹ with respect to 30° C. at 1 kHz. This attribute is important for dielectrics, especially when applied in energy storage, where it ensures a stable output energy density in capacitors, thus underscoring the practical value of PCBDT. The commercial PET shows a temperature-dependent variability in its dielectric constants, especially when the temperature is close to its Tg. In comparison, the dissipation factors of PCBDT are within 1% across the temperature range spanning from 30° C. to 150° C. and frequencies ranging from 1 Hz to 10 kHz, while those of PET increase substantially when the temperature increases, especially at low frequencies, e.g., the dissipation factor can reach about 21% at 1 Hz under 150° C. The high loss and the drastic change of the dielectric constant are due to the α relaxation caused by the large-scale movement of the main chain. The linear chain in the backbone of PET is much more flexible when the temperature is higher than Tg, contributing to the large scale of movement of the main chain.

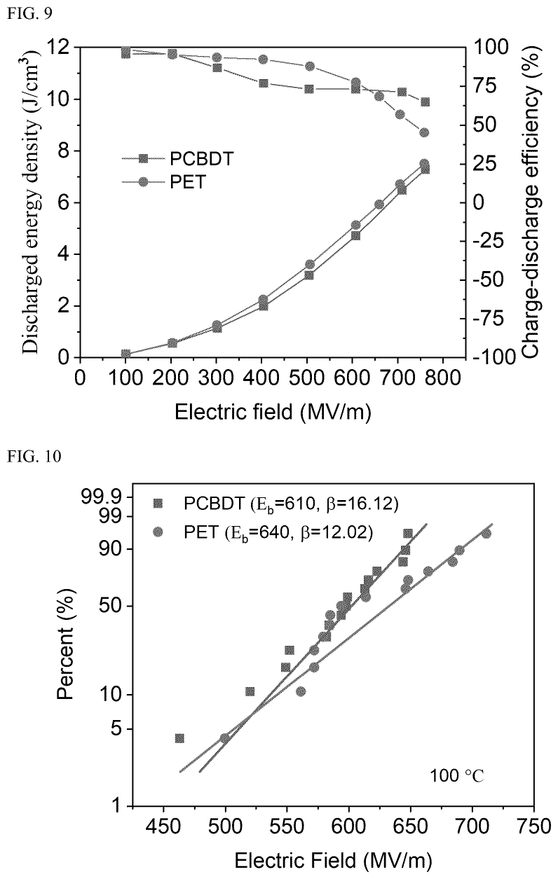

The high-field capacitive energy storage properties of PCBDT were evaluated at room temperature and 100° C. PCBDT demonstrates a competitive performance when compared to the widely used commercial capacitor polymer PET. At room temperature, PCBDT can deliver an impressive discharged energy density of approximately 8.0 J/cm³ under 800 MV/m with a charge-discharge efficiency that is above 75%, which is close to the performance of PET (FIG. 8). When the temperature increases to 100° C., although the charge-discharge efficiency of PCBDT drops when the electric field is increased to 300 MV/m, PCBDT shows a higher charge-discharge efficiency compared to PET in a higher field (FIG. 9). For instance, under 760 MV/m, the efficiency is around 65% for PCBDT while that of commercial PET is 45%. Thus, PCBDT can reach a maximum discharged energy density of 7.3 J/cm³ at 100° C., which is very close to the maximum discharged energy density of PET (7.5 J/cm³). The Weibull statistic breakdown strength of PCBDT at 100° C. is 610 MV/m, close to that of PET (640 MV/m), as shown in FIG. 10, indicating the potential of PCBDT to be a bio-based alternative to PET dielectrics with virtually identical capacitive performance.

Conclusion: CBD is one of several naturally occurring cannabinoids that have a diol structure. The bifunctionality of the monomer aids in synthesizing different condensation polymers with tunable properties for various applications. Poly(cannabinoids), in general, showcase a fascinating alternative to producing new polymers from renewable sources. The high Tg of pCBDT is obtained by reducing the flexibility of the polymer backbone and increasing the rigidity of the side group. A large band gap is maintained because the change in the polymer structure did not increase the conjugation of the molecule. PCBDT exhibits stable dielectric constant, low dielectric loss, high breakdown strength, and well-balanced high-field charging-discharging properties. The hydrolytic degradability of pCBDT further promotes the recyclability of the polymer, which also shows good resistance to dissolution in oxidative environments. The life cycle of cannabinoid polymers for capacitive energy storage originate from hemp and cannabis biomass, isolation of cannabinoids, polymerization into polymers and films, processing into polymer dielectric capacitors, use of the capacitors for capacitive energy storage in a variety of applications (automotive, aerospace, etc.), chemical recycling of cannabinoids or environmental degradation.

### Example 3. Polycannabinoids as Anti-Corrosion Coatings

A solution of polycannabinoid PCBD-Adipate at 1 g/ml in acetone was prepared. Using a waterpaint brush, the solution was brushed on half of a welded steel plate substrate (both front and back) and air dried. The other half of the plate remained untreated. The steel plate had a dimension of about 6 inches×6 inches (15.2 cm×15.2 cm). The steel plate was then placed outside on a railroad tie in Storrs CT in November.

The surface of the steel plate was observed on days 5, 23, 44, 70, and 112. Review of the side of the plate coated with polycannabinoid revealed that propagation of rust did not take place.

Observation: Film of PCBD-Adipate is transparent and colorless upon application. After 60 days exposure outside to the elements, rust was observed on the untreated half of the steel plate. Observation of the half coated with PCBD-Adipate film reveals that it appears the PCBD-Adipate has reversed the rusting process.

### Example 4. Emulsion Polymerization of Cannabinoid for High Performance Coating Applications

Cannabidiol latex particles were prepared by emulsion polymerization. Emulsion polymerization of cannabidiol is feasible from the allylic double bond site in the structure. The final nanosized polymer particles called latex can be used for coating applications as it coalesces together by water evaporation to form a polymer film, a novel application of polymer made from cannabidiol.

The composition and reaction conditions of polyCBD-based latex particles are reported in Table 3.

TABLE 3

Monomer - CBD in Myrcene
Initiator - Water Soluble (ammonium persulphate)
Solvent - Water
Emulsifier - Surfactant (sodium dodecyl sulphate)
Buffer - pH (sodium bicarbonate)
Optional ingredients:
Defoamer/Anti foaming agent - 0.3-0.5% by weight
Freeze/thaw stabilizer/humectants - 0.5-0.8% by weight
Temp. - 70-80° C.
Particle Size - 20-40 nm
pH - 8-10
Solids - 40-50%

CBD-Myrcene Monomer Preparation: Take 1 g of CBD powder and add into 10 ml of myrcene. CBD powder instantly dissolves inside the myrcene. That is the CBD-myrcene monomer solution polyCBD-co-myrcene emulsion polymerization.

The procedure can be applicable for the preparation of CBG-Myrcene and other cannabinoid-Myrcene monomer solutions.

PolyCBD-co-Myrcene Emulsion Synthesis Procedure: Take 0.25 g of sodium dodecyl sulphate, 0.15 g of buffer and 25 ml of DI water in round bottom flask. Start stirring with a magnetic stirrer for 5 minutes and raise the temperature to 70-80° C. Provide an Argon blanket to the reaction. Subsequently, the CBD in myrcene solution was added in the mixture. Reaction was left for 20 minutes at 70-80° C. After that add thermal initiator ammonium persulphate in aqueous solution (0.035 g in 5 ml water). Run the reaction for 10 hours. After 10 hours, cool down the temperature and collect the emulsion.

The procedure can be applicable for the preparation of CBG-co-Myrcene and CBD-CBG-co-Myrcene polymer and other cannabinoid-co-Myrcene polymers.

PolyCBD latex particles copolymerized with any petroleum-based monomer (i.e. polyCBD-styrene-MMA). The above-described Emulsion Synthesis Procedure can be used with other petroleum-based monomers, where instead of myrcene, styrene and MMA mixture or styrene or MMA individually can be used to dissolve CBD and CBG. Examples of other suitable monomers besides myrcene include 1,3-butadiene, styrene, vinyl acetate, acrylates, methacrylates, and the like according to the following structure, or a combination thereof.

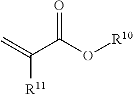

R¹¹=H or CH₃; R¹⁰=C₁-C₁₀ alkyl, e.g. methyl, ethyl, n-butyl, hydroxyethyl, etc.

Polymer synthesis of CBD and CBG by emulsion polymerization to form polyCBD or poly CBG can form polymers of the following structures.

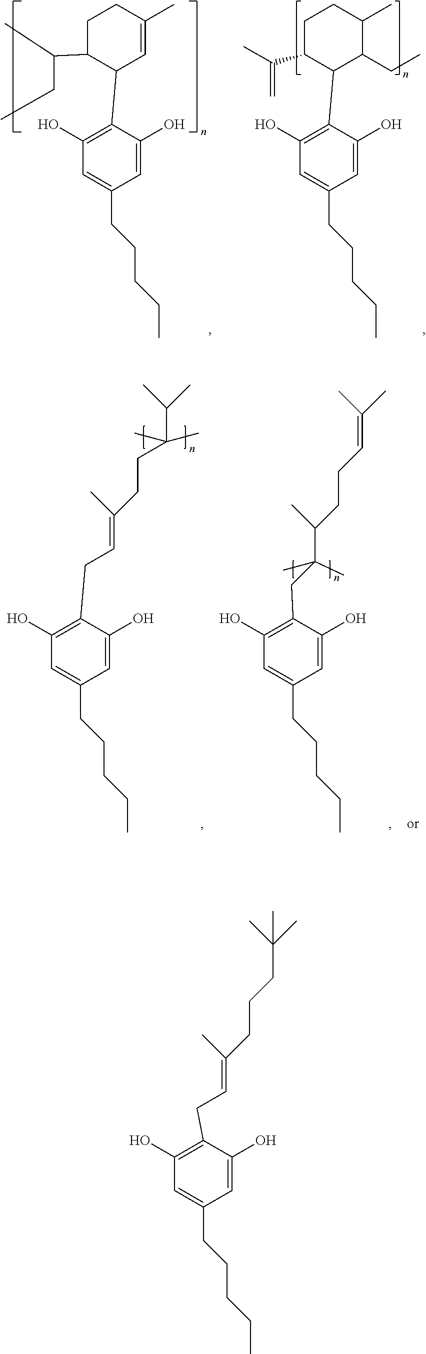

Polymerization of myrcene can form polymers of the following structures.

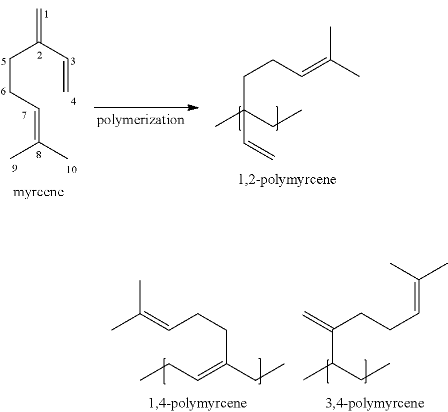

Polymerization of styrene and MMA form polymers of the following structures.

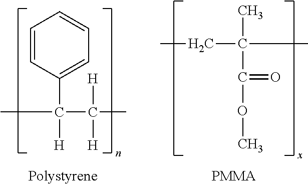

Table 4 reports properties of the latex including Particle Size Distribution (PSD) by dynamic light scattering (DLS) which measures the hydrodynamic radius (R_{H}).

TABLE 4

| Latex | pH | NVM (% wt.) | PSD (nm) | Tg(° C.) |
|---|---|---|---|---|
| Styrene:MMA | 9.51 | 25.45 | 26.6 | 110 |
| Myrcene | 5.03 | 16.36 | 35.0 | |
| Styrene:Myrcene | 8.85 | 6.36 | 19.8 | |
| MMA:Myrcene | 8.81 | 17.27 | | |
| CBD in Styrene:MMA | 9.05 | 35.45 | 28.3 | 100 |

PolyCBD cross-linked latex particles (i.e. polyCBD-diisocyanate, diacid): The above synthesized polyCBD latex particles can be further reacted with the diisocyanate (aromatic, aliphatic or alicyclic), diacid (aromatic, aliphatic, or alicyclic), or any epoxy functional groups. For example, the carboxyl and hydroxyl groups of BA-MMA-MAA can be cross-linked with cycloaliphatic diepoxide in a latex system. Similar types of cross-linking reaction and core shell structure could be made with CBD and CBG in myrcene/terpenes with various other functional monomers.

Materials and Methods for Examples 5-16: Cannabidiol (CBD) was purchased from EcoGen BioSciences and used as received. Cannabigerol (CBG) was purchased from Mile High Labs, Inc and used as received. All other chemicals were purchased from Sigma Aldrich and used without further purification unless otherwise noted. Unless otherwise indicated, ¹H NMR was collected using a Bruker AVANCE 500 MHz instrument. Thermo Gravimetric Analysis was conducted using a TA Instruments TGA Q-500 and DSC was collected using a TA Instruments DSC Q-20. GPC was taken using a WATERS GPC equipped with a 1515 HPLC Pump and Waters 717Plus Autoinjector. Ultra Performance Liquid Chromatograph tandem Mass Spectrometry (UPLC/MS/MS) was conducted using a Waters Acquity UPLC-TQD equipped with a PDA detector.

### Example 5. Preparation of Sebacoyl Chloride

To a flame dried 25 mL round bottom flask was added 5 grams (24.7 mmol) of sebacic acid and 10 mL (137.8 mmol) of thionyl chloride. A reflux condenser was added to the flask and the solution allowed to stir at 90° Celsius for 3 hours until all the solid acid had dissolved. After cooling to room temperature, excess thionyl chloride was removed under vacuum. Five mL of anhydrous toluene was added and removed under vacuum to further remove excess thionyl chloride. The clear yellow solution was further purified by vacuum distillation to yield a colorless oil (5 grams, yield 84.6%).

### Example 5A. Preparation of Cannabidiol Polyester—Poly(Cannabidiol-Sebacate

To a flame dried 25 mL three-neck round bottom flask, containing a solution of 10 mL anhydrous DCM and 5 mL of anhydrous Pyridine, 1 gram (3.2 mmol) of dry CBD was dissolved. Next, 0.68 mL of freshly made and distilled sebacoyl chloride (3.2 mmol) was added dropwise at room temperature over 10 minutes and the reaction allowed to stir at room temperature for 96 hours. The viscous solution was precipitated using dry-ice cold methanol. The solid was collected by filtering and dried under vacuum for 2 days to give 1.3 grams of white polymer; yield 81%. ¹H NMR (400 MHz, CDCl₃): δ 6.68 (s, 2H), 5.20 (s, 1H), 4.54 (s, 1H), 4.46 (s, 1H), 3.51-3.45 (m, 1H), 2.69-2.27 (m, 7H), 2.20-1.97 (m, 2H), 1.89-1.47 (m, 16H), 1.46-1.40 (m, 12H), 0.87 (t, 3H).

### Example 5B. Preparation of Cannabidiol Polyester—Poly(Cannabidiol-Sebacate

20 mL of anhydrous methylene chloride (DCM) and 10 mL of anhydrous pyridine were added to a flame-dried 50 mL two-neck round bottom flask. 1.0 gram (0.00318 mol) of cannabidiol (CBD) was added to the solution and allowed to dissolve while stirring. The solution was then chilled to 0° C. in an ice-water bath. 0.68 mL (0.00318 mol) of Sebacoyl Chloride was then added dropwise over 30 minutes and the reaction stirred for 4 days. After some time, the solution turned from cloudy white to a transparent light-yellow. After the reaction finished, it was concentrated and precipitated in cold methanol to give white polymer strands (1.52 g, 86% yield). Mn 28 k, PDI 1.52. ¹H NMR (500 MHz, CDCl₃): S (ppm): 6.68 (s, 2H), 5.19 (s, 1H), 4.54 (s, 1H), 4.46 (s, 1H), 3.48 (s, 1H), 2.64 (t, 1H), 2.55-2.32 (m, 6H), 2.13 (m, 1H), 2.03-1.99 (m, 1H), 1.81-1.56 (m, 13H), 1.45-1.22 (m, 13H), 0.81 (t, 3H).

### Example 6. Preparation of Cannabidiol Polyurethane

To a flame dried three-neck round bottom flask was added 1 gram (3.2 mmol) of dry CBD and 20 mL of anhydrous DCM. Next, 0.456 mL (3.2 mmol) of TDI (tolylene-2,4-diisocyanate) is added to the solution and stirred for 15 minutes. After stirring, 1 mL of a stock solution of DMAP in anhydrous DCM (2 mg/mL) was added to the flask. A reflux condenser was attached to the flask and the solution refluxed for 24 hours. After the reaction finished, the solution was quenched with dry-ice cold methanol. The solid was collected by filtering and dried under vacuum for 2 days to give 1.42 grams of white polymer; yield 84%.

### Example 7. Preparation of Cannabidiol Polyester—Poly(Cannabidiol-Adipate

80 mL of anhydrous methylene chloride (DCM) and 40 mL of anhydrous pyridine were added to a dried 250 mL two-neck round bottom flask. 10 grams (0.0318 mol) of cannabidiol (CBD) was added to the solution and allowed to dissolve while stirring. The solution was then chilled to 0° C. in an ice-water bath. 4.66 mL (0.0318 mol) of Adipoyl Chloride was then added dropwise over 30 minutes and the reaction stirred for 4 days. On day 3, the solution turned from cloudy white to a transparent light-yellow. After the reaction was finished, it was concentrated and precipitated in cold methanol to give white polymer strands (12.15 g, 90% yield). Mn 21 k, PDI 1.63. ¹H NMR (500 MHz, CDCl₃): S (ppm): 6.75 (s, 2H), 5.25 (s, 1H), 4.59 (s, 1H), 4.51 (s, 1H), 3.54 (d, 1H), 2.58 (m, 7H), 2.18 (m, 1H), 2.09 (m, 1H), 1.86-1.63 (m, 14H), 1.35 (m, 4H), 0.92 (t, 3H).

### Example 8. Preparation of Cannabigerol Polyester—Preparation of Poly(Cannabigerol-Adipate

80 mL of anhydrous methylene chloride (DCM) and 40 mL of anhydrous pyridine were added to a dried 250 mL two-neck round bottom flask. 10 grams (0.0316 mol) of cannabigerol (CBG) was added to the solution and allowed to dissolve while stirring. The solution was then chilled to 0° C. in an ice-water bath. 4.62 mL (0.0316 mol) of Adipoyl Chloride was then added dropwise over 30 minutes and the reaction stirred for 4 days. On day 3, the solution turned from cloudy white to a transparent light-yellow. After the reaction was finished, it was concentrated and precipitated in cold methanol to give white polymer strands (11.73 g, 87.6% yield). Mn 21 k, PDI 1.61. ¹H NMR (500 MHz, CDCl₃): S (ppm): 6.82 (s, 2H), 5.07 (m, 2H), 3.17 (m, 2H), 2.68-2.50 (m 6H), 2.07 (m, 2H), 1.99 (m, 2H)1.90 (m, 4H), 1.77-1.57 (m, 11H), 1.36 (m, 4H), 0.93 (t, 3H).

### Example 9. Preparation of Cannabigerol Polyester—Poly(Cannabigerol-Sebacate

20 mL of anhydrous methylene chloride (DCM) and 10 mL of anhydrous pyridine were added to a dried 50 mL two-neck round bottom flask. 1.0 grams (0.0316 mol) of cannabigerol (CBG) was added to the solution and allowed to dissolve while stirring. The solution was then chilled to 0° C. in an ice-water bath. 0.67 mL (0.0316 mol) of Sebacoyl Chloride was then added dropwise over 30 minutes and the reaction stirred for 4 days. On day 3, the solution turned from cloudy white to a transparent light-yellow. After the reaction was finished, it was concentrated and precipitated in cold methanol to give white polymer strands (1.47 g, 83.4% yield). ¹H NMR (500 MHz, CDCl₃): S (ppm): 6.75 (s, 2H), 5.07-5.01 (m, 2H), 3.12 (d, 2H), 2.59-2.48 (m, 6H), 2.02 (m, 2H), 1.93 (m, 2H), 1.77-1.69 (m, 4H), 1.68-1.57 (m, 10H), 1.44-1.25 (m, 13H), 0.88 (t, 3H).

### Example 10. Preparation of Co-Polyester—Preparation of poly(Cannabidiol-co-Cannabigerol-Adipate

20 mL of anhydrous chloroform (CHCl₃) and 10 mL of anhydrous pyridine were added to a flame-dried 50 mL two-neck round bottom flask. 1.258 grams (0.00398 mol) of cannabigerol (CBG) and 1.25 grams (0.00398 mols) of cannabidiol (CBD) was added to the solution and allowed to dissolve while stirring. The solution was then chilled to 0° C. in an ice-water bath. 1.165 mL (0.00795 mol) of Adipoyl Chloride was then added dropwise over 30 minutes and the reaction stirred for 4 days. On day 3, the solution turned from cloudy white to a transparent light-yellow. After the reaction was finished, it was concentrated and precipitated in cold methanol to give white polymer strands (3.5 g, 88%.3 yield). ¹H NMR (500 MHz, CDCl₃): S (ppm): 6.77 (s, 2H), 6.70 (s, 2H), 5.20 (s, 1H), 5.04 (m, 2H), 4.55 (s, 1H), 4.46 (s, 1H), 3.52-3.43 (m, 1H), 3.12 (d, 2H), 2.66-2.38 (m, 13H), 2.19-2.07 (m, 2H), 2.06-1.98 (m, 3H), 1.89-1.71 (m, 10H), 1.69 (s, 3H), 1.65 (s, 6H), 1.62-1.52 (m, 9H), 1.35-1.23 (m, 8H), 0.92-0.81 (m, 6H).

### Example 11. Preparation of Co-Polyester—Preparation of poly(Cannabidiol-co-Olivetol-Adipate

20 mL of anhydrous chloroform (CHCl₃) and 10 mL of anhydrous pyridine were added to a flame-dried 50 mL two-neck round bottom flask. 1.25 grams (0.00398 mols) of cannabidiol (CBD) was added to the solution and allowed to dissolve while stirring. The solution was then chilled to 0° C. in an ice-water bath. 1.165 mL (0.00795 mol) of Adipoyl Chloride was then added dropwise over 30 minutes and the reaction stirred for 4 days. On day 3, the solution turned from cloudy white to a transparent light-yellow. After the reaction was finished, it was concentrated and precipitated in cold methanol to give brown polymer strands (3.5 g, 88%.3 yield). ¹H NMR (500 MHz, CDCl₃): S (ppm): 6.80 (s, 2H), 6.74 (m, 1H), 6.70 (s, 2H), 5.20 (s, 1H), 4.55 (s, 1H), 4.46 (s, 1H), 2.79-2.35 (m, 14H), 2.19-2.07 (m, 1H), 2.06-1.96 (m, 1H), 1.90-1.49 (m, 20H), 1.37-1.24 (m, 8H), 0.92-0.82 (m, 6H).

### Example 12. Preparation of Cannabidiol Polyester—Poly(Cannabidiol-Terephthalate

10 mL of anhydrous methylene chloride (DCM) and 10 mL of anhydrous pyridine were added to a flame-dried 50 mL two-neck round bottom flask. 1.0 grams (0.00318 mols) of cannabidiol (CBD) was added to the solution and allowed to dissolve while stirring. The solution was then chilled to 0° C. in an ice-water bath. Terephthaloyl Chloride (0.6456 grams, 0.00318 mols), dissolved in 10 mL of anhydrous DCM, was then added dropwise over 30 minutes and the reaction stirred for 4 days. After the reaction was finished, it was precipitated in cold methanol to give a white, flakey solid (1.45 grams, 88.1% yield).

### Example 13. Preparation of Cannabigerol Polyester—Poly(Cannabigerol-Terephthalate

10 mL of anhydrous methylene chloride (DCM) and 10 mL of anhydrous pyridine were added to a flame-dried 50 mL two-neck round bottom flask. 1.006 grams (0.00318 mols) of cannabigerol (CBG) was added to the solution and allowed to dissolve while stirring. The solution was then chilled to 0° C. in an ice-water bath. Terephthaloyl Chloride (0.6456 grams, 0.00318 mols), dissolved in 10 mL of anhydrous DCM, was then added dropwise over 30 minutes and the reaction stirred for 4 days. After the reaction was finished, it was precipitated in cold methanol to give a white, flakey solid (1.36 grams, 82.4% yield).

### Example 14. Preparation of Cannabidiol-Diacetate

50 mL of anhydrous methylene chloride (DCM) and 6 mL of freshly distilled triethylamine (TEA) was added to a flame dried 100 mL two-neck round bottom flask. 5 grams (15.9 mmol) of cannabidiol (CBD) was added to the solution and dissolved while stirring. The solution was then chilled to 0° C. in an ice-water bath. Excess acetyl chloride (3.0 mL, 42 mmol) was added to the solution dropwise over 15 minutes. The reaction turned white, cloudy after addition of the acetyl chloride. After several hours, the solution became clear orange and was stirred for an additional 96 hours. After the reaction finished, the solvent was stripped using rotary evaporation, leaving crude orange oil. The oil was then redissolved in ethyl acetate, which precipitated protonated TEA salts. The mixture was filtered, and the liquid was washed with water (3×20 mL) and brine (3×20 mL). The aqueous washings were extracted with ethyl acetate (2×20 mL). Organic fractions were collected dried and concentrated using rotary evaporation to yield a viscous light-yellow oil. The oil was further purified using column chromatography using a 1:9 ratio of ethyl acetate to hexane. The product was concentrated using rotary evaporation and left to dry on a vacuum line overnight to give a viscous, colorless oil (5.97 g, 94% yield). 1H NMR (500 MHz, CDCl₃): S (ppm): 6.71 (s, 2H), 5.19 (s, 1H), 4.55 (s, 1H), 4.45 (s, 1H), 3.50 (d, 1H), 2.65 (td, 1H), 2.54 (t, 2H), 2.19 (m, 7H), 2.04-2.01 (d, 1H), 1.83-1.69 (m, 2H), 1.67 (s, 3H), 1.63-1.53 (m, 5H), 1.30 (m, 4H), 0.88 (t, 3H).

### Example 15. Preparation of Cannabigerol-Diacetate

50 mL of anhydrous methylene chloride (DCM) and 6 mL of freshly distilled triethylamine (TEA) was added to a flame dried 100 mL two-neck round bottom flask. 5 grams (15.79 mmol) of cannabigerol (CBG) was added to the solution and dissolved while stirring. The solution was then chilled to 0° C. in an ice-water bath. Excess acetyl chloride (3.0 mL, 42 mmol) was added to the solution dropwise over 15 minutes. The reaction turned white, cloudy after addition of the acetyl chloride. After several hours, the solution became clear orange and was stirred for an additional 96 hours. After the reaction finished, the solvent was stripped using rotary evaporation, leaving crude orange oil. The oil was then redissolved in ethyl acetate, which precipitated protonated TEA salts. The mixture was filtered, and the liquid was washed with water (3×20 mL) and brine (3×20 mL). The aqueous washings were extracted with ethyl acetate (2×20 mL). Organic fractions were collected dried and concentrated using rotary evaporation to yield a viscous light-yellow oil. The oil was further purified using column chromatography using a 1:9 ratio of ethyl acetate to hexane. The product was concentrated using rotary evaporation and left to dry on a vacuum line overnight to give a viscous, colorless oil (5.74 g, 91% yield). 1H NMR (500 MHz, CDCl₃): S (ppm): 6.77 (s, 2H), 5.05 (m, 2H), 3.15 (d, 2H), 2.56 (t, 2H), 2.27 (s, 6H), 2.05 (m, 3H), 1.95 (m, 2H), 1.71 (s, 3H), 1.65 (s, 3H), 1.60 (m, 4H), 1.31 (m, 4H), 0.88 (t, 3H).

### Example 16. Preparation of Poly(CBD-Adipate) Films

18 wt. % of CBD in 1,4-dioxane solution was prepared by using Thinky Planetary Centrifugal Mixer (rotation+revolution) for improved dissolution, uniformity, and degassing. Films were cast on glass substrate having a smooth surface, by using a motorized drawdown coater. The doctor blade was set to an initial casting thickness of 203 μm.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. “Combination” is inclusive of blends, mixtures, alloys, reaction products, and the like. When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. “Or” means “and/or.” The suffix “(s)” as used herein is intended to include both the singular and the plural of the term that it modifies, thereby including one or more of that term (e.g., the film(s) includes one or more films). The terms “including” and “having” are intended to be inclusive such that there may be additional elements other than the listed elements. The term “exemplary” is not intended to be construed as a superlative example but merely one of many possible examples. Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the de-scribed elements may be combined in any suitable manner in the various embodiments.

The modifier “about” used in connection with a quantity is inclusive of the stated value and has the meaning dictated by the context (e.g., includes the degree of error associated with measurement of the particular quantity). The notation “+10%” means that the indicated measurement can be from an amount that is minus 10% to an amount that is plus 10% of the stated value. “Optional” or “optionally” means that the subsequently described event or circumstance can or cannot occur, and that the description includes instances where the event occurs and in-stances where it does not. Unless defined otherwise, technical and scientific terms used herein have the same meaning as is commonly understood by one of skill in the art to which this invention belongs.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements de-scribed in an exemplary embodiment without departing from the scope of the various embodiments as set forth in the appended claims.

What is claimed is:

1. An electrochromic material composition, comprising
a salt;
a polycannabinoid; and
optionally a plasticizer, a solvent, or a combination thereof;
wherein the polycannabinoid comprises a plurality of cannabinoid units, wherein the polycannabinoid has the formula: 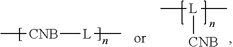
wherein:
CNB is a cannabinoid unit,
L is a linking group; and
n represents the number of repeat units wherein n is at least 2;
wherein the linking group comprises a di- or tri-carboxylic acid linking group comprising citric acid, fumaric acid, glutamic acid, maleic acid, malic acid, terephthalic acid, isophthalic acid, naphthalene-2,6-dicarboxylic acid, oxaloacetic acid, phthalic acid, butanedioic acid, oxalic acid, malonic acid, succinic acid, glutaric acid, adipic acid, pimelic acid (heptanedioic acid), suberic acid (octanedioic acid), azelaic acid (nonanedioic acid), sebacic acid (decanedioic acid), undecanedioic acid, dodecanedioic acid, pyridine-2,6-dicarboxylic acid, 1H-imidazole-4,5-dicarboxylic acid, furan-2,5-dicarboxylic acid, furan-2,3-dicarboxylic acid, thiophene-2,5-dicarboxylic acid, thiophene-2,3-dicarboxylic acid, quinoline-2,4-dicarboxylic acid, cyclohexane-1,4-dicarboxylic acid, cyclopentane-1,3-dicarboxylic acid, cyclobutane-1,3-dicarboxylic acid, or bicyclo[2.2.2]octane-1,4-dicarboxylic acid, or a bifunctional compound such as

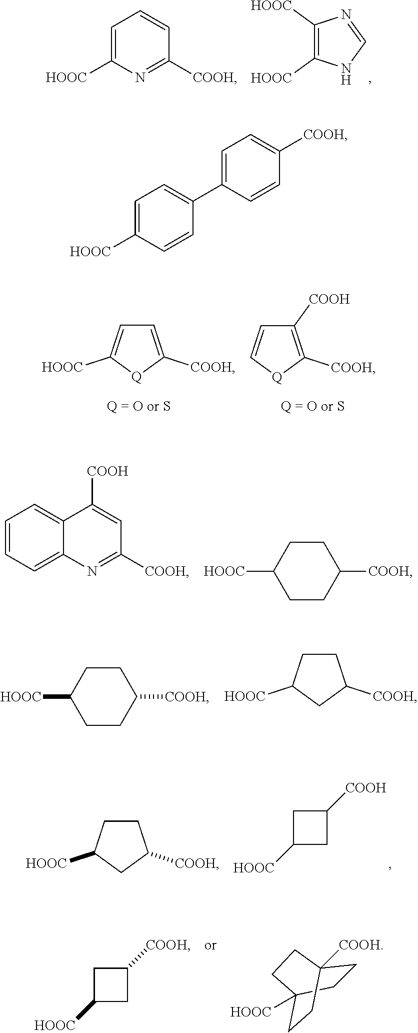

2. The electrochromic material composition of claim 1, wherein each cannabinoid unit is independently derived from CBG, CBD, CBC, CBND, dihydro-DHCBD, CBG-V, CBD-V, CBC-V, CBND-V, or dihydro-DHCBD-V; and
wherein each cannabinoid unit is bound to the linking group via hydroxyl groups, acid groups, or ester groups on the cannabinoid unit before polymerization.

3. The electrochromic material composition of claim 1, wherein each cannabinoid unit has one of the following structures before polymerization: 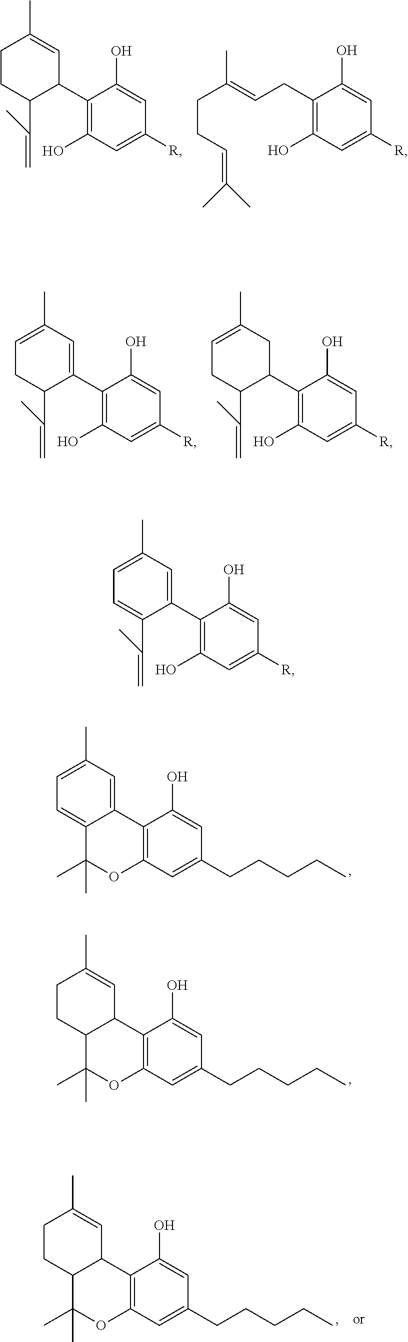 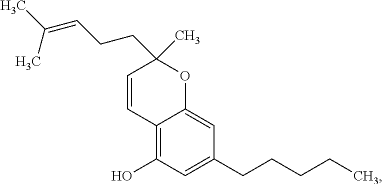 [SMILES: CCCCCc1cc(O)c2c(c1)OC(C)(CCC=C(C)C)C=C2]
and
wherein the R group is: C₁-C₁₀ alkyl optionally substituted with one or more heteroatoms, a heterocycloalkyl group, or a heteroaryl group.

4. The electrochromic material composition of claim 1, wherein the polymer further comprises a linear or branched hydrocarbon chain containing from 3 to 50 carbon atoms, optionally interrupted with one or more oxygen atoms or aromatic groups.

5. The electrochromic material composition of claim 1, wherein the polycannabinoid is poly(cannabidiol terephthalate).

6. The electrochromic material composition of claim 1, wherein the salt is a metal salt, an organic salt (e.g., ionic liquids), an inorganic salt, or a combination thereof; specifically the salt comprises an alkali metal ion M wherein the salt is MClO₄, MPF₆, MBF₄, MAsF₆, MSbF₆, MCF₃SO₃, MCF₃CO₂, M₂C₂F₄(SO₃)₂, MN(CF₃SO₂)₂, MN(C₂F₅SO₂)₂, MC(CF₃SO₂)₃, MCₙF₂ₙ₊₁SO₃ (2≤n≤3), MN(RfOSO₂)₂ (wherein Rf is a fluoroalkyl group), or a combination thereof.

7. The electrochromic material composition of claim 1, wherein the salt is an ionic liquid based on imidazolium, pyridinium, phosphonium or tetralkylammonium, specifically 1-ethyl-3-methylimidazolium tosylate, 1-butyl-3-methylimidazolium octyl sulfate; 1-butyl-3-methylimidazolium 2-(2-methoxyethoxy)ethyl sulfate; 1-ethyl-3-methylimidazolium bis(pentafluoroethylsulfonyl)imide; 1-ethyl-3-methylimidazolium bis(trifluoromethylsulfonyl)imide; 1-ethyl-3-methylimidazolium bromide; 1-ethyl-3-methylimidazolium hexafluorophosphate; 1-butyl-3-methylimidazolium bromide; 1-butyl-3-methylimidazolium trifluoromethane sulfonate; 1,2-dimethyl-3-propylimidazolium tris(trifluoromethylsulfonyl)methide; 1,2-dimethyl-3-propylimidazolium bis(trifluoromethylsulfonyl)imide; 3-methyl-1-propylpyridinium bis(trifluormethylsulfonyl)imide; 1-butyl-3-methylpyridinium bis(trifluormethylsulfonyl)imide; 1-butyl-4-methylpyridinium chloride; 1-butyl-4-methylpyridinium hexafluorophosphate; 1-butyl-4-methylpyridinium tetrafluoroborate; 1-n-butyl-3-methylimidazolium hexafluorophosphate (n-BMIM PF₆); 1-butyl-3-methylimidazolium tetrafluoroborate (BMIM BF₄); phosphonium dodecylbenzenesulfonate; phosphonium methanesulfonate; or a combination thereof.

8. A method of forming an electrochromic film, comprising,
providing a solution or homogeneous suspension comprising the electrochromic material composition of claim 1 comprising the salt, the polycannabinoid, the solvent, and optionally the plasticizer; and
forming an electrochromic film from the solution or suspension.

9. The method of claim 8, wherein the forming comprises ink jet printing, screen printing, roll to roll printing, reel to reel processing, spin coating, meniscus and dip coating, spray coating, brush coating, flow coating, doctor blade application, solution casting, curtain casting, or drop casting.

10. A film formed by the method of claim 8.

11. An electrochromic device, comprising the electrochromic material composition of claim 1.

12. An article comprising the electrochromic material composition of claim 1, wherein the article is eyewear including glasses, goggles, visor, sunglasses, laser protection, automotive mirror, automotive window, automotive sunroof, automotive car panels, windows, smart glass, displays, billboards, signs, video monitors, flat panel displays, flexible displays, sensors, OLEDs, LCDS, solar cells, electrochromic fabric, electrochromic textile, adaptive camouflage, electrochromic plastic wrap for food, household goods, packaging, a container, luggage tag, or flooring.

13. An electrochromic device comprising:
an electrochromic layer comprising the electrochromic material composition of claim 1, and
an electrolyte layer,
wherein the electrochromic layer is adjacent to the electrolyte layer.

14. The electrochromic device of claim 13, wherein the electrolyte layer comprises a salt, wherein the salt is a metal salt, an organic salt (e.g., ionic liquids), an inorganic salt, or a combination thereof, specifically the salt comprises an alkali metal ion M wherein the salt is MClO₄, MPF₆, MBF₄, MAsF₆, MSbF₆, MCF₃SO₃, MCF₃CO₂, M₂C₂F₄(SO₃)₂, MN(CF₃SO₂)₂, MN(C₂F₅SO₂)₂, MC(CF₃SO₂)₃, MCₙF₂ₙ₊₁SO₃ (2≤n≤3), MN(RfOSO₂)₂ (wherein Rf is a fluoroalkyl group), or a combination thereof.

15. The electrochromic device of claim 14, wherein the electrolyte layer comprises a salt, wherein the salt is an ionic liquid based on imidazolium, pyridinium, phosphonium or tetralkylammonium, specifically 1-ethyl-3-methylimidazolium tosylate, 1-butyl-3-methylimidazolium octyl sulfate; 1-butyl-3-methylimidazolium 2-(2-methoxyethoxy)ethyl sulfate; 1-ethyl-3-methylimidazolium bis(pentafluoroethylsulfonyl)imide; 1-ethyl-3-methylimidazolium bis(trifluoromethylsulfonyl)imide; 1-ethyl-3-methylimidazolium bromide; 1-ethyl-3-methylimidazolium hexafluorophosphate; 1-butyl-3-methylimidazolium bromide; 1-butyl-3-methylimidazolium trifluoromethane sulfonate; 1,2-dimethyl-3-propylimidazolium tris(trifluoromethylsulfonyl)methide; 1,2-dimethyl-3-propylimidazolium bis(trifluoromethylsulfonyl)imide; 3-methyl-1-propylpyridinium bis(trifluormethylsulfonyl)imide; 1-butyl-3-methylpyridinium bis(trifluormethylsulfonyl)imide; 1-butyl-4-methylpyridinium chloride; 1-butyl-4-methylpyridinium hexafluorophosphate; 1-butyl-4-methylpyridinium tetrafluoroborate; 1-n-butyl-3-methylimidazolium hexafluorophosphate (n-BMIM PF₆); 1-butyl-3-methylimidazolium tetrafluoroborate (BMIM BF₄); phosphonium dodecylbenzenesulfonate; phosphonium methanesulfonate; or a combination thereof.

16. A dielectric film capacitor, comprising a polycannabinoid, wherein the polycannabinoid comprises a plurality of cannabinoid units, wherein the polycannabinoid has the formula: 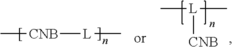
wherein:
CNB is a cannabinoid unit,
L is a linking group; and
n represents the number of repeat units wherein n is at least 2;
wherein the linking group comprises a di- or tri-carboxylic acid linking group comprising citric acid, fumaric acid, glutamic acid, maleic acid, malic acid, terephthalic acid, isophthalic acid, naphthalene-2,6-dicarboxylic acid, oxaloacetic acid, phthalic acid, butanedioic acid, oxalic acid, malonic acid, succinic acid, glutaric acid, adipic acid, pimelic acid (heptanedioic acid), suberic acid (octanedioic acid), azelaic acid (nonanedioic acid), sebacic acid (decanedioic acid), undecanedioic acid, dodecanedioic acid, pyridine-2,6-dicarboxylic acid, 1H-imidazole-4,5-dicarboxylic acid, furan-2,5-dicarboxylic acid, furan-2,3-dicarboxylic acid, thiophene-2,5-dicarboxylic acid, thiophene-2,3-dicarboxylic acid, quinoline-2,4-dicarboxylic acid, cyclohexane-1,4-dicarboxylic acid, cyclopentane-1,3-dicarboxylic acid, cyclobutane-1,3-dicarboxylic acid, or bicyclo[2.2.2]octane-1,4-dicarboxylic acid, or a bifunctional compound such as

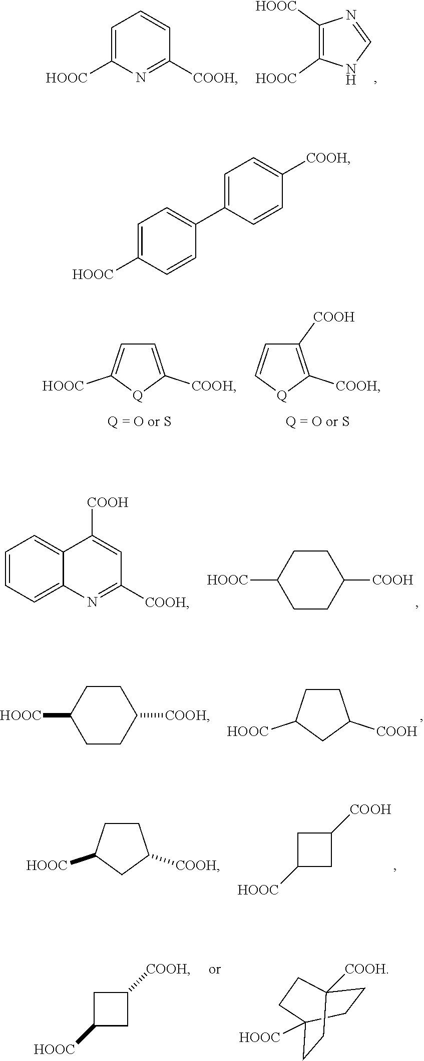

17. The dielectric film capacitor of claim 16, wherein each cannabinoid unit is independently derived from CBG, CBD, CBC, CBND, dihydro-DHCBD, CBG-V, CBD-V, CBC-V, CBND-V, or dihydro-DHCBD-V; and
wherein each cannabinoid unit is bound to the linking group via hydroxyl groups, acid groups, or ester groups on the cannabinoid unit before polymerization.

18. The dielectric film capacitor of claim 16, wherein each cannabinoid unit has one of the following structures before polymerization: 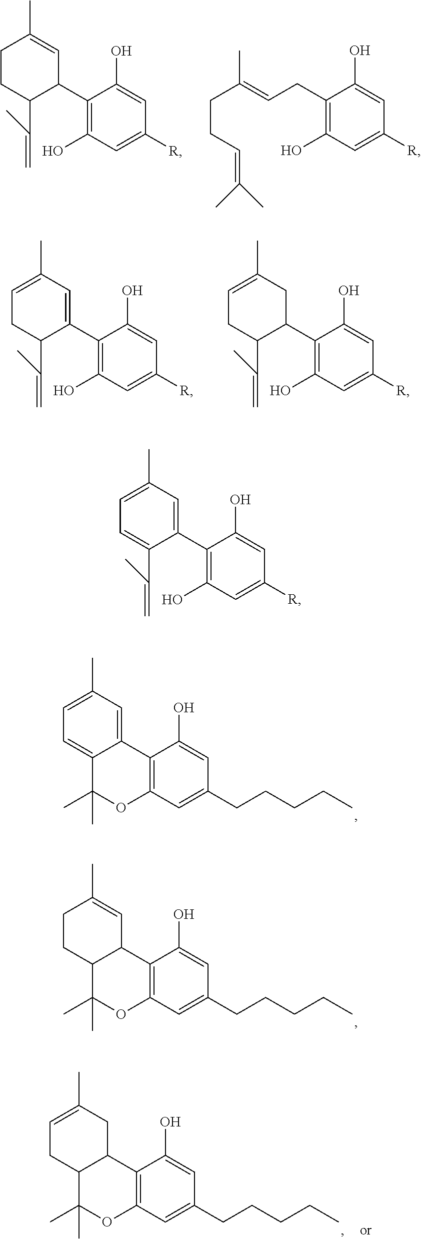 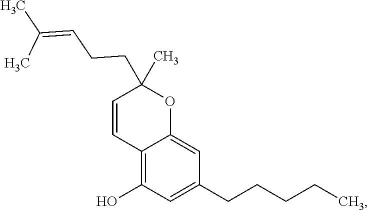 [SMILES: CCCCCc1cc(O)c2c(c1)OC(C)(CCC=C(C)C)C=C2]
wherein the R group is: C₁-C₁₀ alkyl optionally substituted with one or more heteroatoms, a heterocycloalkyl group, or a heteroaryl group.

19. The dielectric film capacitor of claim 16, wherein the polymer further comprises a linear or branched hydrocarbon chain containing from 3 to 50 carbon atoms, optionally interrupted with one or more oxygen atoms or aromatic groups.

20. The dielectric film capacitor of claim 16, wherein the polycannabinoid is poly(cannabidiol terephthalate).

21. A dielectric film capacitor, comprising the dielectric film capacitor of claim 16 between two electrodes.

22. A paint or coating, comprising:
a polycannabinoid and
a solvent or liquid carrier, a pigment, an extender, a rheology modifier, an additive, or a combination thereof,
wherein the polycannabinoid comprises a plurality of cannabinoid units, wherein
A.) the polycannabinoid is a polycannabinoid latex polymer prepared from emulsion polymerization of a cannabinoid monomer, optionally copolymerized with another monomer comprising an unsaturated group; or
B.) the polycannabinoid has the formula: 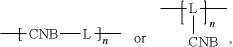
wherein:
CNB is a cannabinoid unit,
L is a linking group; and
n represents the number of repeat units wherein n is at least 2;
wherein the linking group comprises a di- or tri-carboxylic acid linking group comprising citric acid, fumaric acid, glutamic acid, maleic acid, malic acid, terephthalic acid, isophthalic acid, naphthalene-2,6-dicarboxylic acid, oxaloacetic acid, phthalic acid, butanedioic acid, oxalic acid, malonic acid, succinic acid, glutaric acid, adipic acid, pimelic acid (heptanedioic acid), suberic acid (octanedioic acid), azelaic acid (nonanedioic acid), sebacic acid (decanedioic acid), undecanedioic acid, dodecanedioic acid, pyridine-2,6-dicarboxylic acid, 1H-imidazole-4,5-dicarboxylic acid, furan-2,5-dicarboxylic acid, furan-2,3-dicarboxylic acid, thiophene-2,5-dicarboxylic acid, thiophene-2,3-dicarboxylic acid, quinoline-2,4-dicarboxylic acid, cyclohexane-1,4-dicarboxylic acid, cyclopentane-1,3-dicarboxylic acid, cyclobutane-1,3-dicarboxylic acid, or bicyclo[2.2.2]octane-1,4-dicarboxylic acid, or a bifunctional compound such as

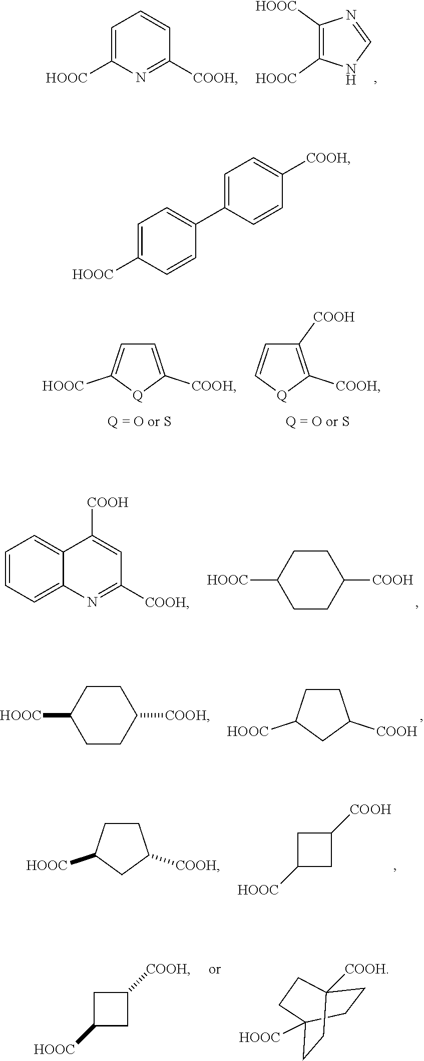

23. The paint or coating of claim 22, wherein
A.) the polycannabinoid is a polycannabinoid latex polymer prepared from emulsion polymerization of a cannabinoid monomer copolymerized with an additional monomer comprising an unsaturated group, wherein the additional monomer is a terpene, 1,3-butadiene, styrene, vinyl acetate, an acrylate, a methacrylate, or a combination thereof.

24. The paint or coating of claim 22, wherein
B.) the polycannabinoid has the formula: 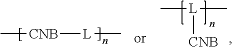
wherein each cannabinoid unit is independently derived from CBG, CBD, CBC, CBND, dihydro-DHCBD, CBG-V, CBD-V, CBC-V, CBND-V, or dihydro-DHCBD-V; and
wherein each cannabinoid unit is bound to the linking group via hydroxyl groups, acid groups, or ester groups on the cannabinoid unit before polymerization.

25. The paint or coating of claim 24, wherein each cannabinoid unit has one of the following structures before polymerization: 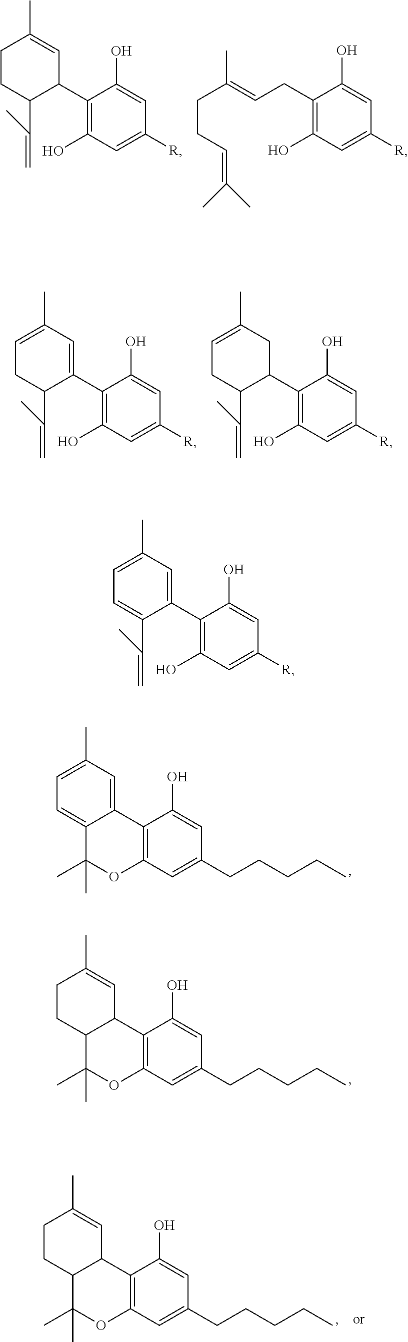 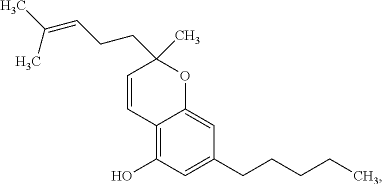 [SMILES: CCCCCc1cc(O)c2c(c1)OC(C)(CCC=C(C)C)C=C2]
and
wherein the R group is: C₁-C₁₀ alkyl optionally substituted with one or more heteroatoms, a heterocycloalkyl group, or a heteroaryl group.

26. The paint or coating of claim 24, the polymer further comprises a linear or branched hydrocarbon chain containing from 3 to 50 carbon atoms, optionally interrupted with one or more oxygen atoms or aromatic groups.

27. A substrate coated with the paint or coating of claim 22.
